(19) United States
(12) Patent Application Publication
(10) Pub. No.: US 2014/0365557 A1
(43) Pub. Date: Dec. 11, 2014

(54) INFORMATION PROCESSING DEVICE, CONTENT DISTRIBUTION METHOD, AND CONTENT DISTRIBUTION SYSTEM

(71) Applicant: FUJITSU LIMITED, Kawasaki-shi (JP)

(72) Inventors: Satoshi Maehara, Yokohama (JP); Masaharu KAKO, Tokai (JP)

(73) Assignee: FUJITSU LIMITED, Kawasaki-shi (JP)

(21) Appl. No.: 14/270,453

(22) Filed: May 6, 2014

(30) Foreign Application Priority Data
Jun. 10, 2013 (JP) 2013-122266

(51) Int. Cl. H04L 29/08

(52) U.S. Cl. CPC H04L 67/1097
USPC 709/203

(57) ABSTRACT

An information processing device including: a first storage unit that stores content; a second storage unit that stores session information including a home address and a care-of address of a mobile terminal, a home address of a virtual proxy, distribution content, and a state of the session; and a processing unit that updates, when a location registration request is received from a mobile terminal that is establishing a session, session information based on the location registration request, searches for an information processing device located near the mobile terminal, and notifies the detected information processing device of the session information and that transmits, when session information related to a mobile terminal that is establishing a session with another information processing device is received, to the mobile terminal, a location registration request including an address of the virtual proxy and distributes content included in the session information.

### CROSS-REFERENCE TO RELATED APPLICATION

This application is based upon and claims the benefit of priority of the prior Japanese Patent Application No. 2013-122266, filed on Jun. 10, 2013, the entire contents of which are incorporated herein by reference.

### FIELD

The present invention relates to an information processing device, a content distribution method, and a content distribution system for distributing content.

### BACKGROUND

To efficiently distribute content, Web content distribution often adopts a system, in which a plurality of cache servers are arranged, the content is dispersed to the cache servers, and a client downloads content from a neighborhood cache server. An example of the system includes a CDN (Contents Delivery Network).

FIG. 1 is a diagram illustrating an example of the CDN system. A plurality of Replicas are arranged in the CDN system. The Replicas are cache servers, and the Replicas are managed by, for example, an ISP (Internet Service Provider) and exist in a network of the ISP. In the example illustrated in FIG. 1, one Replica acts as a master server, and the other Replicas act as slave servers. In FIG. 1, the master server is described as a Replica #Master, and the slave servers are described as Replicas #1 to #3. Unless particularly distinguished, it is simply described as a Replica.

The Replica #Master acquires, through the Internet, content from a Web server that has an original of the content and holds the content in a cache. The Replicas #1 to #3 download the content from the Replica #Master and hold the content in caches. A mobile terminal accesses a neighborhood Replica and establishes a TCP (Transmission Control Protocol) communication session with the Replica to download the content. In this case, the Replica acts as a virtual proxy for the mobile terminal. Therefore, the communication session is settled between the mobile terminal and the Replica, and the traffic in the network can be reduced.

If the requested content is not held in the cache upon access from the mobile terminal, the Replica acquires the content from the Replica #Master and holds the content in the cache. If the requested content is not held in the cache of the Replica #Master, the Replica #Master downloads the content from the Web server that has the original content and provides the content to the Replica or the mobile terminal.

### PATENT DOCUMENT

[Patent document 1] Japanese Patent Laid-Open No. 2003-289327

However, the conventional content distribution technique has the following problems. FIG. 2 is a diagram for describing the problems in the conventional content distribution technique. FIG. 2 illustrates a CDN system similar to that of FIG. 1.

The virtual proxy is an object created in the Replica accessed first by the mobile terminal. Even when the mobile terminal moves to a different link, the mobile terminal continues to download the content from the virtual proxy in the Replica if the communication session with the virtual proxy in the Replica accessed first is maintained.

For example, in the example illustrated in FIG. 2, if the mobile terminal moves from a link connecting the Replica #1 to a link connecting the Replica #2 while the communication session is established, the mobile terminal continues to download the content from the Replica #1. The Replica #2 is located closer to the mobile terminal at the movement destination, and the Replica #2 holds the same content in the cache. However, since the mobile terminal continues to download the content from the Replica #1, extra traffic is generated in the network, and the efficiency is low.

Furthermore, in order for the mobile terminal to download the content from the Replica #2 in the link at the movement destination, the mobile terminal usually disconnects the communication session with the Replica #1 to establish a communication session with the Replica #2. A user of the mobile terminal performs operation of ending a Web browser, etc., to disconnect the communication session with the Replica #1, and the operation is burdensome for the user.

### SUMMARY

An aspect of the present invention provides an information processing device including:

a first storage unit that stores content;

a second storage unit that stores session information including a home address and a care-of address of a mobile terminal that is establishing a session, a home address for a session with the mobile terminal, distribution content, and a state of the session; and

a processing unit

that updates, when a location registration request is received from a mobile terminal that is establishing a session, session information related to the mobile terminal based on the location registration request, searches for an information processing device located near the mobile terminal based on an address of the mobile terminal included in the location registration request, and notifies the detected information processing device of the session information after the update related to the mobile terminal and

that transmits, when session information related to a mobile terminal that is establishing a session with another information processing device is received, to the mobile terminal, a location registration request including an address used in a session with the mobile terminal included in the session information and distributes content included in the session information.

Another aspect of the present invention provides a content distribution system including a plurality of information processing devices described above. Furthermore, another aspect of the present invention provides a content distribution method in which the information processing device executes the process. Furthermore, other aspects of the present invention can include a program causing a computer to function as the information processing device and a computer-readable non-transitory recording medium recording the program. The non-transitory recording medium readable by a computer and the like is a recording medium, in which information, such as data and programs, is accumulated by electrical, magnetic, optical, mechanical, or chemical operation, and the information can be read from the computer and the like.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a CDN system;

FIG. 2 is a diagram for describing problems in a conventional content distribution technique;

FIG. 3 is a diagram illustrating an example of a configuration of a content distribution system according to a first embodiment;

FIG. 4 is a diagram illustrating an example of a hardware configuration of a cache server;

FIG. 5 is a diagram illustrating an example of functional blocks of the cache server as a Replica according to the first embodiment;

FIG. 6 is an example of a communication destination registration table;

FIG. 7 is an example of a session information table;

FIG. 8 is an example of a UE neighborhood Replica determination table;

FIG. 9 is an example of a virtual proxy home agent management table;

FIG. 10 is a diagram illustrating an example of a processing sequence in the content distribution system in the first embodiment;

FIG. 11A is a diagram illustrating an example of an HTTP GET message transmitted from a mobile terminal to an address of a Replica #1 in OP11 of FIG. 10;

FIG. 11B is a diagram illustrating an example of an HTTP GET message transmitted to an address of a Replica when the mobile terminal handles a link connecting the Replica #1 as a foreign link;

FIG. 12 is a diagram illustrating an example of a packet of HTTP redirection transmitted from the Replica #1 to the mobile terminal in OP12 of FIG. 10;

FIG. 13 is a diagram illustrating an example of an HTTP GET message transmitted from the mobile terminal to the Replica #1 in OP13 of FIG. 10;

FIG. 14 is a diagram illustrating an example of a response packet of the HTTP GET message transmitted from the Replica #1 to the mobile terminal in OP14 of FIG. 10;

FIG. 15 is a diagram illustrating an example of BU transmitted from the mobile terminal to a terminal home agent 5 in OP18 of FIG. 10;

FIG. 16A is a diagram illustrating an example of BU transmitted from the mobile terminal to a virtual proxy in the Replica #1 that is establishing a session in OP21 of FIG. 10;

FIG. 16B is a diagram illustrating an example of a packet of the BU transmitted from the mobile terminal to a virtual proxy in a Replica that is establishing a session;

FIG. 17 is a diagram illustrating an example of BU transmitted from a virtual proxy in a Replica #2 to a virtual proxy home agent in OP24 of FIG. 10;

FIG. 18 is a diagram illustrating an example of BU transmitted from the virtual proxy in the Replica #2 to a mobile terminal 4 in OP25 of FIG. 10;

FIG. 19 is an example of a flow chart of a process by a virtual proxy processing unit when the HTTP GET message to the address of the Replica is received;

FIG. 20A is an example of a flow chart of a process by the virtual proxy processing unit when a TCP packet to the address of the virtual proxy in the Replica is received;

FIG. 20B is an example of the flow chart of the process by the virtual proxy processing unit when the TCP packet to the address of the virtual proxy in the Replica is received;

FIG. 20C is an example of the flow chart of the process by the virtual proxy processing unit when the TCP packet to the address of the virtual proxy in the Replica is received;

FIG. 20D is an example of the flow chart of the process by the virtual proxy processing unit when the TCP packet to the address of the virtual proxy in the Replica is received;

FIG. 21 is an example of the communication destination registration table and the session information table of the Replica #1 after the process of OP14 of FIG. 10;

FIG. 22 is an example of a flow chart of a process by the virtual proxy processing unit when the BU is received from the mobile terminal;

FIG. 23 is an example of a flow chart of a process by the virtual proxy processing unit as a Replica at a handover destination when records of the communication destination registration table and the session information table are received from another Replica;

FIG. 24 is an example of the communication destination registration tables and the session information tables of the Replica #1 and the Replica #2 after the process of OP23 of FIG. 10;

FIG. 25 is an example of a flow chart of a process by the virtual proxy home agent processing unit as the virtual proxy home agent when the BU is received from the virtual proxy;

FIG. 26 is an example of the virtual proxy home agent management tables of the Replica #1 and the Replica #2 after the process of OP24 of FIG. 10;

FIG. 27 is an example of a flow chart of a process by the virtual proxy home agent processing unit as the virtual proxy home agent when the TCP packet is received from the mobile terminal;

FIG. 28 is an example of the communication destination registration table according to a second embodiment;

FIG. 29 is an example of the virtual proxy home agent management table according to the second embodiment;

FIG. 30 is a diagram illustrating an example of a sequence of a process in the content distribution system according to the second embodiment;

FIG. 31 is an example of an HTTP GET message transmitted from the mobile terminal to the address of the Replica #1 in OP31 of FIG. 30;

FIG. 32 is a diagram illustrating an example of a packet of a response message (HTTP 200 OK) of the HTTP GET message transmitted from the Replica #1 to the mobile terminal in OP32 of FIG. 30;

FIG. 33A is a diagram illustrating an example of a packet of BU transmitted from the mobile terminal to the virtual proxy in the Replica #1 that is establishing a session in OP39 of FIG. 30;

FIG. 33B is a diagram illustrating an example of a packet of BU transmitted from the mobile terminal to the virtual proxy in the Replica #1 that is establishing a session in OP39 of FIG. 30;

FIG. 34 is a diagram illustrating an example of a packet of BU transmitted from the virtual proxy in the Replica #2 to a virtual proxy home agent 3 in OP42 of FIG. 30;

FIG. 35 is a diagram illustrating an example of a packet of BU transmitted from the virtual proxy in the Replica #2 to the mobile terminal 4 in OP43 of FIG. 30;

FIG. 36 is a diagram illustrating an example of an IP in IP packet transmitted from the virtual proxy home agent to the virtual proxy in the Replica #2 in OP44 of FIG. 30;

FIG. 37 is an example of a flow chart of a process by the virtual proxy processing unit when a content request to the address of the Replica is received;

FIG. 38 is an example of a flow chart of a process by the virtual proxy processing unit as a Replica at the handover destination when records of the communication destination registration table and the session information table are received from another Replica;

FIG. 39 is an example of a flow chart of a process by the virtual proxy home agent processing unit as the virtual proxy home agent when the BU is received from the virtual proxy;

FIG. 40 is an example of a flow chart of a process by the virtual proxy home agent processing unit as the virtual proxy home agent when the TCP packet is received from the mobile terminal;

FIG. 41 is an example of the communication destination registration table according to a third embodiment;

FIG. 42 is a diagram illustrating an example of a sequence of a process in the content distribution system according to the third embodiment;

FIG. 43 is an example of a flow chart of a process by the virtual proxy home agent processing unit as the virtual proxy home agent when the TCP packet is received from the mobile terminal; and

FIG. 44 is an example of a flow chart of a process by the virtual proxy processing unit when the TCP packet is received from the virtual proxy home agent.

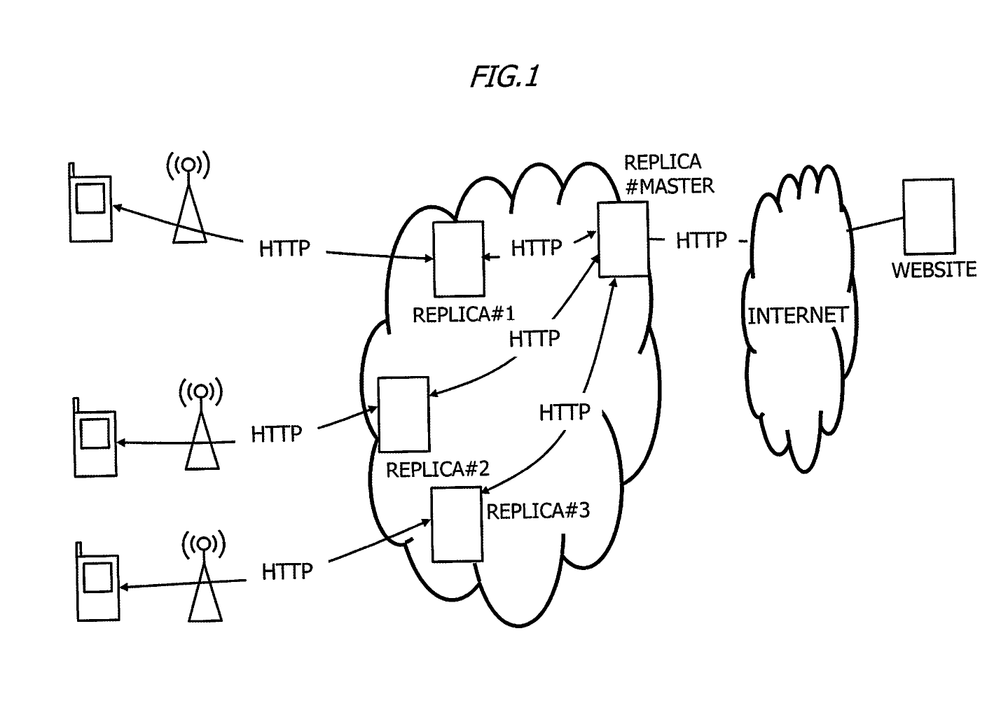

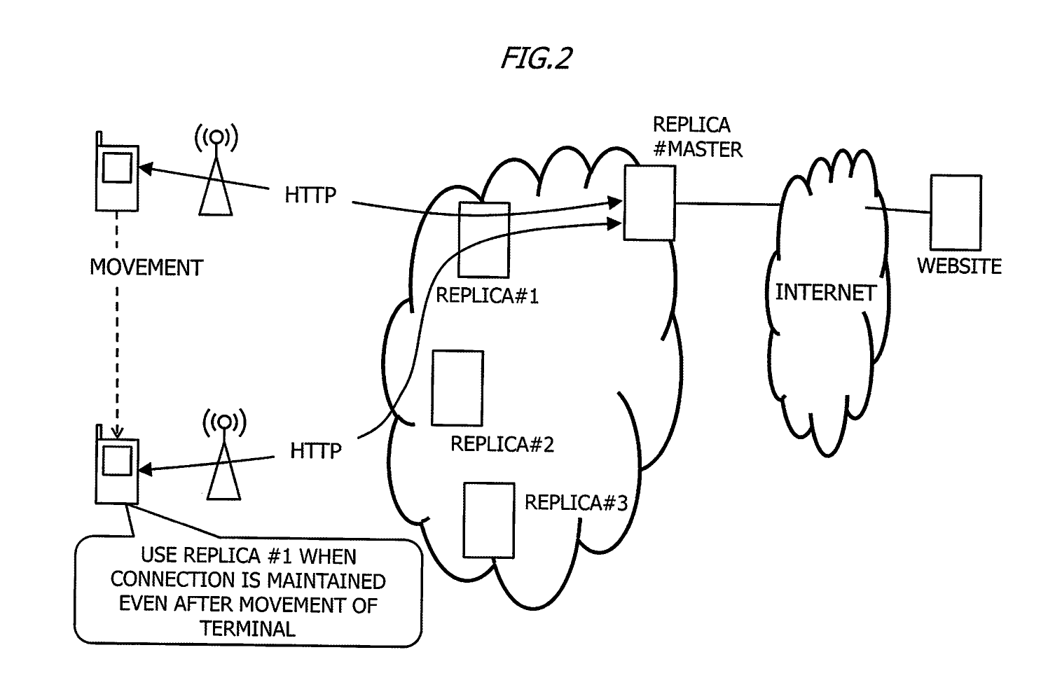

### DESCRIPTION OF EMBODIMENTS

Hereinafter, embodiments of the present invention will be described with reference to the drawings. Configurations of the following embodiments are illustrative, and the present invention is not limited to the configurations of the embodiments.

### First Embodiment

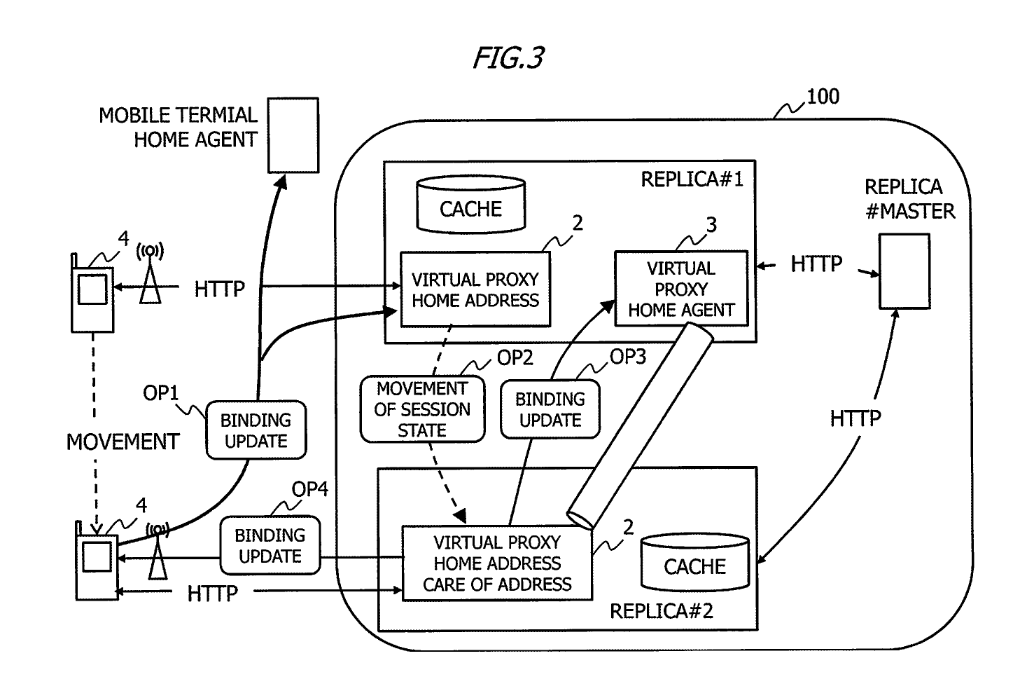

FIG. 3 is a diagram illustrating an example of a configuration of a content distribution system according to a first embodiment. A content distribution system 100 includes a plurality of Replicas. However, in the example illustrated in FIG. 3, a Replica #1, a Replica #2, and a Replica #Master are extracted and illustrated for the convenience. Furthermore, although the content distribution system illustrated in FIG. 3 is based on a CDN, the system is not limited to this.

It is assumed that Mobile IPv6 is adopted in the content distribution system 100 illustrated in FIG. 3. The content distribution system 100 illustrated in FIG. 3 is not limited to the IPv6, and the first embodiment can also be applied when IPv4 is adopted.

The Mobile IPv6 is one of the extension specifications of IPv6, and the Mobile IPv6 maintains the connectivity even after a movement to another network, while holding the same IP address. In the Mobile IPv6, a mobile terminal (User Equipment: also described as UE) and a virtual proxy in the Replica use a home address and a care-of address to maintain the connectivity to the network. In the present specification, a “link” is used synonymously with a “network”. Furthermore, the fact that the links are the same means that network addresses are the same.

The home address is an address used in a home link of the mobile terminal. The care-of address is an address allocated to a link (foreign link) at a movement destination, and the address changes according to a change in the link caused by movement of the mobile terminal. A home agent that manages the correspondence between the home address and the care-of address of the mobile terminal exists in the home link. When the mobile terminal moves to a foreign link and acquires a new care-of address, the mobile terminal notifies the home agent of the new care-of address. If there is a communication partner that is establishing a communication session, the communication partner is also notified of the care-of address. The association of the home address and the care-of address is called location registration in the Mobile IP. The care-of address is notified by transmitting Binding Update. The Binding Update will be described as BU hereinafter. The BU is also called a location registration request.

In the Mobile IPv6, as data is transmitted to the home address, the home agent forwards the data to the care-of address and acts as a relay station. Therefore, even if the communication partner exists in the foreign link, and the care-of address is not known, the data reaches the communication partner.

The example illustrated in FIG. 3 illustrates an example that the mobile terminal 4 downloads content. It is assumed that the home link of the mobile terminal 4 is a link connecting the Replica #1 in the first embodiment. It is also assumed that the Replica #2 is connected to a link different from the Replica #1. Therefore, the link connecting the Replica #2 is a foreign link for the mobile terminal 4.

The mobile terminal 4 is first connected to the Replica #1 to download content from the Replica #1. The content is downloaded by, for example, an HTTP (Hypertext Transfer Protocol). In the Replica #1, an object of a virtual proxy 2 is created according to access from the mobile terminal 4. The virtual proxy 2 handles the link connecting the Replica #1 being the creation source as the home link and has a home address allocated by the Replica #1. The virtual proxy 2 serves as a communication partner of the mobile terminal 4.

Furthermore, in the Replica #1 being the creation source of the virtual proxy 2, an object of a virtual proxy home agent 3 also activates. The virtual proxy home agent 3 manages the correspondence between the home address and the care-of address of the virtual proxy 2. The location of the virtual proxy home agent 3 may be in any device within the same link as the Replica #1, and the location is not limited. In the first embodiment, it is assumed that the virtual proxy home agent 3 exists in the same device as an device in which the virtual proxy 2 exists.

If the mobile terminal 4 moves from the link connecting the Replica #1 to the link connecting the Replica #2 while the communication session with the virtual proxy 2 is established, the mobile terminal 4 acquires a care-of address in the link at the movement destination. The mobile terminal 4 transmits BU for notifying the correspondence between the newly acquired care-of address and the home address to a terminal home agent 5 and the virtual proxy 2 as the communication partner (OP1).

The Replica #1 as the creation source of the virtual proxy 2 detects the movement of the mobile terminal 4 to a different link by receiving the BU from the mobile terminal 4. The Replica #1 searches for a Replica located near the mobile terminal 4 from the care-of address of the mobile terminal 4 notified by the BU and detects the Replica #2. The Replica #1 moves the information of the session between the virtual proxy 2 and the mobile terminal 4 to the Replica #2 (OP2). The information of the session between the virtual proxy 2 and the mobile terminal 4 includes, for example, a home address of the virtual proxy 2, a home address and a care-of address of the mobile terminal 4, distribution content, a distribution completion position of the distribution content, and information indicating a session state.

The movement of the information of the session between the virtual proxy 2 and the mobile terminal 4 from the Replica #1 to the Replica #2 denotes movement of the virtual proxy 2 from the home link to a foreign link. Therefore, the virtual proxy 2 moved to the Replica #2 acquires the care-of address and transmits the BU to the virtual proxy home agent 3 of the virtual proxy 2 in the Replica #1 and to the mobile terminal 4 as the communication partner (OP3 and OP4).

Furthermore, the information of the session established between the mobile terminal 4 to be moved from the Replica #1 to the Replica #2 and the virtual proxy 2 also includes the distribution content, the state of session, and the like. Therefore, after the movement to the Replica #2, the virtual proxy 2 uses the information of the session to restart the content distribution from the content distribution completion position, not from the beginning. Communication data to the virtual proxy 2 generated during the movement of the virtual proxy 2 is transferred from the virtual proxy home agent 3 to the virtual proxy 2 after the movement to the Replica #2 through an IP in IP tunnel, in accordance with the specifications of the Mobile IP.

More specifically, in the first embodiment, the virtual proxy 2 moves to the Replica near the mobile terminal according to the movement of the mobile terminal as the communication partner. As a result, the mobile terminal 4 downloads the content from the neighborhood Replicas before and after the movement, and increase in extra traffic in the network can be reduced. From the viewpoint of the user of the mobile terminal 4, the content is continuously distributed before and after the movement without downloading the content again due to the movement or without performing operation for switching the connection destination, and there is no burden or discomfort of operation before and after the movement.

(Configuration of Cache Server)

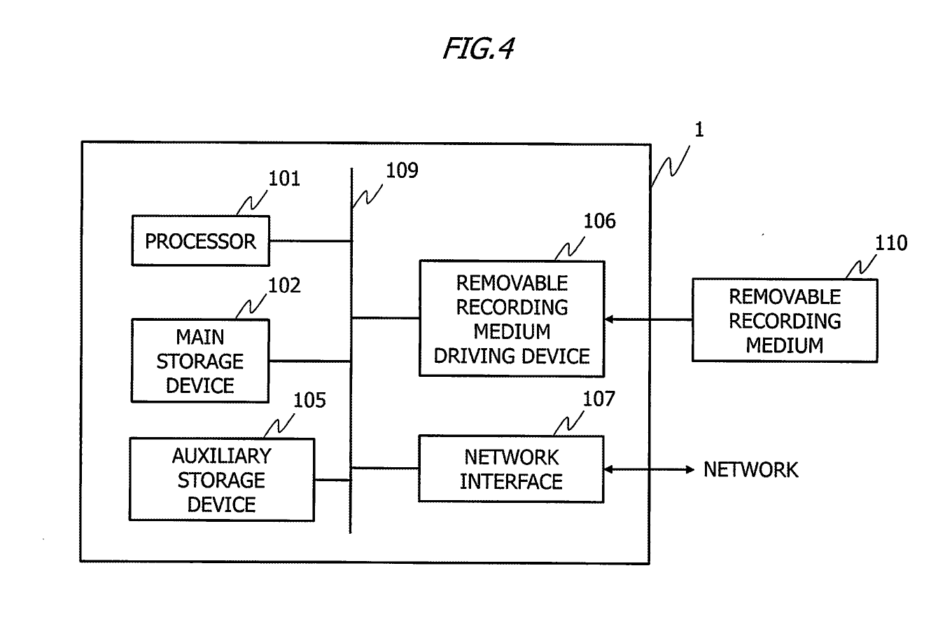

FIG. 4 is a diagram illustrating an example of a hardware configuration of a cache server 1. The cache server 1 is an information processing device that acts as, for example, the Replica #1, the Replica #2, or the Replica #Master in the content distribution system 100 illustrated in FIG. 3. The cache server 1 includes a processor 101, a main storage device 102, an auxiliary storage device 105, a removable recording medium driving device 106, and a network interface 107. These are connected to each other by a bus 109.

The removable recording medium driving device 106 reads programs and various data recorded in the removable recording medium 110 and outputs the programs and the various data to the processor 101. The removable recording medium 110 is, for example, a recording medium, such as an SD card, a miniSD card, a microSD card, a USB (Universal Serial Bus) flash memory, a CD (Compact Disc), a DVD (Digital Versatile Disc), a Blu-ray Disc, and a flash memory card.

The network interface 107 is an interface that inputs and outputs information to and from a network. The network interface 107 includes an interface connected to a wired network and an interface connected to a wireless network. The network interface 107 is, for example, a NIC (Network Interface Card), a wireless LAN (Local Area Network) card, or the like. Data and the like received by the network interface 107 are output to the processor 101. Although the network interface 107 is displayed by one box in FIG. 4 for the convenience, the network interface 107 may include, for example, a plurality of ports.

The auxiliary storage device 105 stores various programs and data used by the processor 101 to execute the programs. The auxiliary storage device 105 is, for example, a non-volatile memory, such as an EPROM (Erasable Programmable ROM) and a hard disk drive. The auxiliary storage device 105 holds, for example, an operating system (OS), a content distribution program, and various other application programs.

The main storage device 102 provides a storage area and a working area for loading a program stored in the auxiliary storage device 105 on the processor 101 and is used as a buffer. The main storage device 102 is, for example, a semiconductor memory, such as a RAM (Random Access Memory) and a ROM.

The processor 101 is, for example, a CPU (Central Processing Unit). The processor 101 loads, on the main storage device 102, the OS and various application programs held in the auxiliary storage device 105 or the removable recording medium 110 and executes the OS and the various application programs to execute various processes. The number of processors 101 is not limited to one, and a plurality of processors 101 may be included.

For example, in the cache server 1, the processor 101 loads the content distribution program held in the auxiliary storage device 105 on the main storage device 102 to execute the content distribution program. The cache server 1 acts as a Replica through the execution of the content distribution program. The hardware configuration of the cache server 1 is an example, and the hardware configuration is not limited to this. Constituent elements can be appropriately omitted, replaced, or added according to embodiments. For example, the cache server 1 may include an input device, such as a mouse and a keyboard, and an output device, such as a display. The content distribution program may be recorded in, for example, the removable recording medium 110. The content distribution program is an example of an “information processing program”.

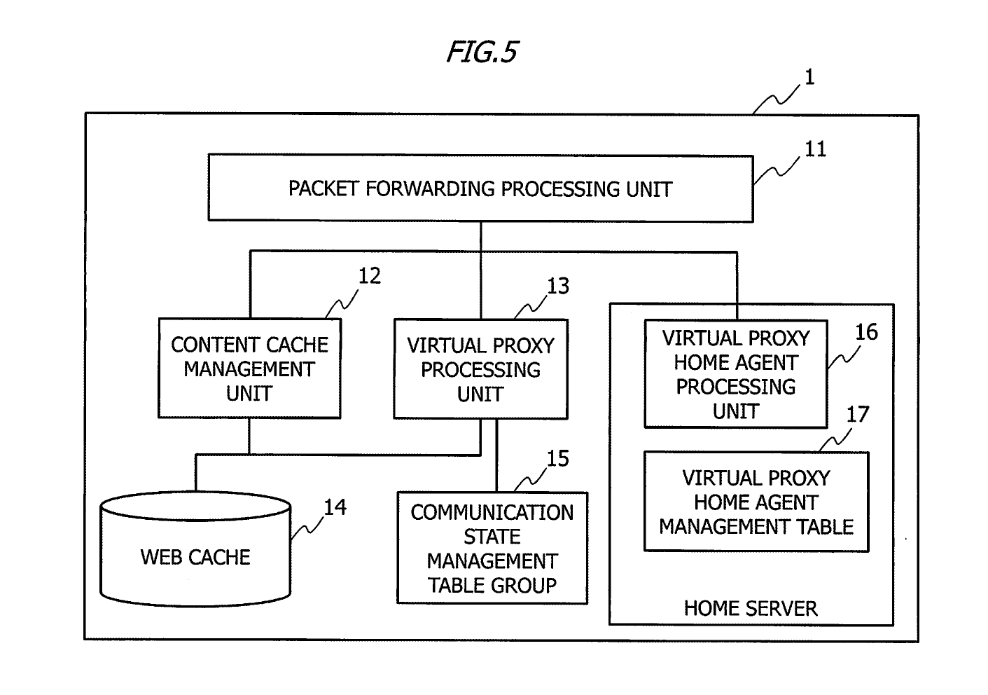

FIG. 5 is a diagram illustrating an example of functional blocks of the cache server 1 as a Replica according to the first embodiment. The cache server 1 executes the content distribution program and includes functional blocks such as a packet forwarding processing unit 11, a content cache management unit 12, a virtual proxy processing unit 13, a Web cache 14, a communication state management table group 15, a virtual proxy home agent 16, and a virtual proxy home agent management table 17. The virtual proxy home agent 16 and the virtual proxy home agent management table 17 are included as functional blocks when the cache server 1 also serves as the virtual proxy home agent 3.

The packet forwarding processing unit 11 allocates a received packet to one of the content cache management unit 12, the virtual proxy processing unit 13, and the virtual proxy home agent processing unit 16. For example, the packet forwarding processing unit 11 identifies a flow and allocates the received packet according to the flow the received packet belongs.

For example, the packet forwarding processing unit 11 forwards a packet of a flow of HTTP (port number on the communication partner side is 80) sent from the cache server 1 to the content cache management unit 12.

The virtual proxy 2 existing in the cache server 1 includes a virtual proxy 2 that handles the link connecting the cache server 1 as a home link and a virtual proxy 2 that handles the link connecting the cache server 1 as a foreign link. Therefore, the destination address of the received packet to the virtual proxy 2 that handles the link connecting the cache server 1 as the home link is the home address of the virtual proxy 2. Furthermore, the destination address of the received packet to the virtual proxy 2 that handles the link connecting the cache server 1 as a foreign link is the care-of address of the virtual proxy 2. Therefore, the packet forwarding processing unit 11 forwards the received packet to the virtual proxy processing unit 13 if the destination address of the received packet is the home address or the care-of address of the virtual proxy 2 existing in the cache server 1.

If the destination address of the received packet is an address described in the virtual proxy home agent management table 17 described later, the packet forwarding processing unit 11 forwards the received packet to the virtual proxy home agent processing unit 16.

The packet forwarding processing unit 11 may refer to, for example, a communication destination registration table described later, the virtual proxy home agent management table 17, and the like to allocate the received packet. Alternatively, for example, a dedicated table other than the tables may be held in the storage area of the auxiliary storage device 105 and referenced.

The content cache management unit 12 manages content in the Web cache 14. For example, if content requested from the virtual proxy processing unit 13 is not held in the Web cache 14, the content is downloaded from the Replica #Master or the Web server and stored in the Web cache 14.

The Web cache 14 holds the content. For example, the Web cache 14 is statically created in advance in the storage area of the auxiliary storage device 105 or dynamically created through the execution of the content distribution program. If, for example, the content held in the Web cache 14 is not accessed for a predetermined period, the content cache management unit 12 deletes the content. The Web cache 14 is an example of a “first storage unit”.

The virtual proxy processing unit 13 executes a process of the virtual proxy 2 existing in the cache server 1. Specifically, for example, when a content request is received from the mobile terminal, the virtual proxy processing unit 13 creates the virtual proxy 2 and transmits the corresponding content to the request source.

Furthermore, when the mobile terminal is moved during the content distribution, and BU is received from the mobile terminal, the virtual proxy processing unit 13 searches for a Replica near the movement destination of the mobile terminal. The virtual proxy processing unit 13 transmits the information of the session between the mobile terminal and the virtual proxy 2 and the like to the detected Replica. Specifically, the information transmitted in this case is corresponding records of the communication destination registration table and the session information table stored in the communication state management table group 15 described later.

Furthermore, when the information of the session between the virtual proxy 2 in the Replica and the mobile terminal and the like are received from another Replica, the virtual proxy processing unit 13 restarts the session between the virtual proxy 2 and the mobile terminal 4 as the communication partner and distributes the content to the mobile terminal 4. Details of the process by the virtual proxy processing unit 13 will be described later. The virtual proxy processing unit 13 is an example of a “processing unit”.

The virtual proxy home agent processing unit 16 executes a process of the home agent of the virtual proxy 2 created in a device connected to the same link including the cache server 1. Details of the process will be described later.

(Data Structures)

The communication state management table group 15 is created in the storage area of the main storage device 102 or the auxiliary storage device 105. The information of the session between the virtual proxy 2 existing in the cache server 1 and the communication partner is stored. A communication destination registration table, a session information table, and a UE neighborhood Replica determination table are stored in the communication state management table group 15.

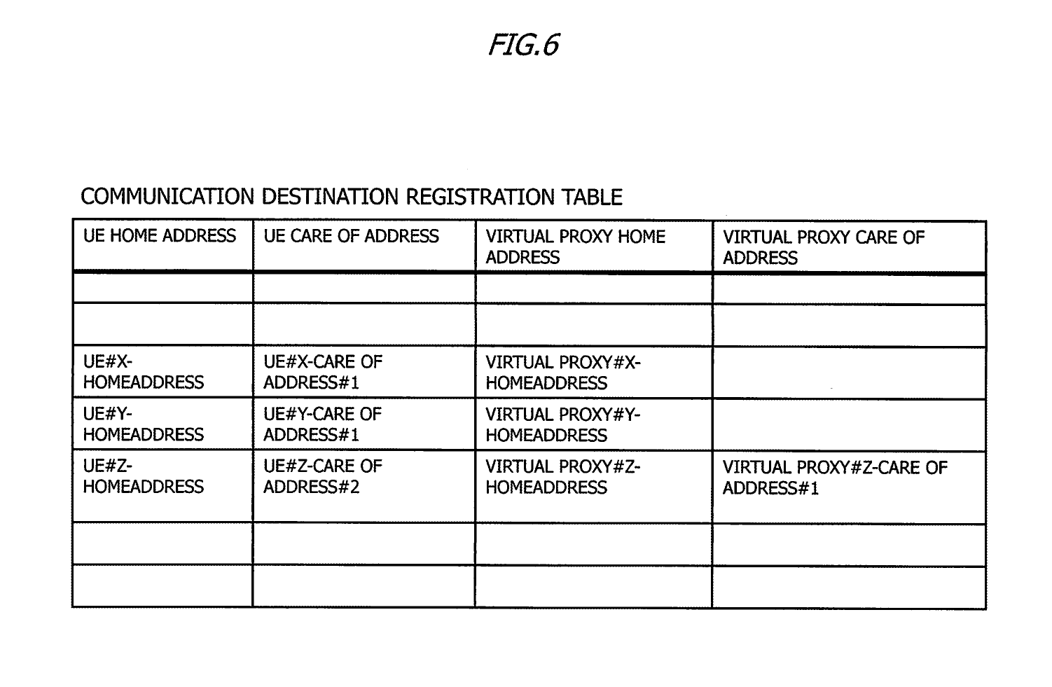

FIG. 6 is an example of the communication destination registration table. The communication destination registration table is a table storing the virtual proxy 2 existing in the cache server 1 and the mobile terminal that is receiving the distribution of the content. The records of the communication destination registration table illustrated in FIG. 6 include items of “UE Home Address”, “UE Care-of Address”, “Virtual Proxy Home Address”, and “Virtual Proxy Care-of Address”.

The mobile terminal does not have a care-of address when connected to the home link. Therefore, the “UE Care-of Address” is not stored if the link connecting the cache server 1 is the home link for the mobile terminal, and the care-of address of the mobile terminal is stored if the link is a foreign link.

The virtual proxy 2 moved from another Replica also exists in the cache server 1. The “Virtual Proxy Care-of Address” is empty if the virtual proxy 2 is created by the cache server 1 or if the link connecting the cache server 1 is the home link. The care-of address of the virtual proxy 2 is stored in the “Virtual Proxy Care-of Address” if the virtual proxy 2 handles the link connecting the cache server 1 as a foreign link.

The records of the communication destination registration table are created and registered by the virtual proxy processing unit 13 when, for example, a first connection request is received from the mobile terminal. The existence of a corresponding record in the communication destination registration table in the first embodiment means that a corresponding virtual proxy 2 exists in the cache server 1. When the content distribution is finished, and the session is disconnected, the virtual proxy processing unit 13 deletes the records of the communication destination registration table. The deletion of the records of the communication destination registration table in the first embodiment means that the corresponding virtual proxy 2 does not exist in the cache server 1.

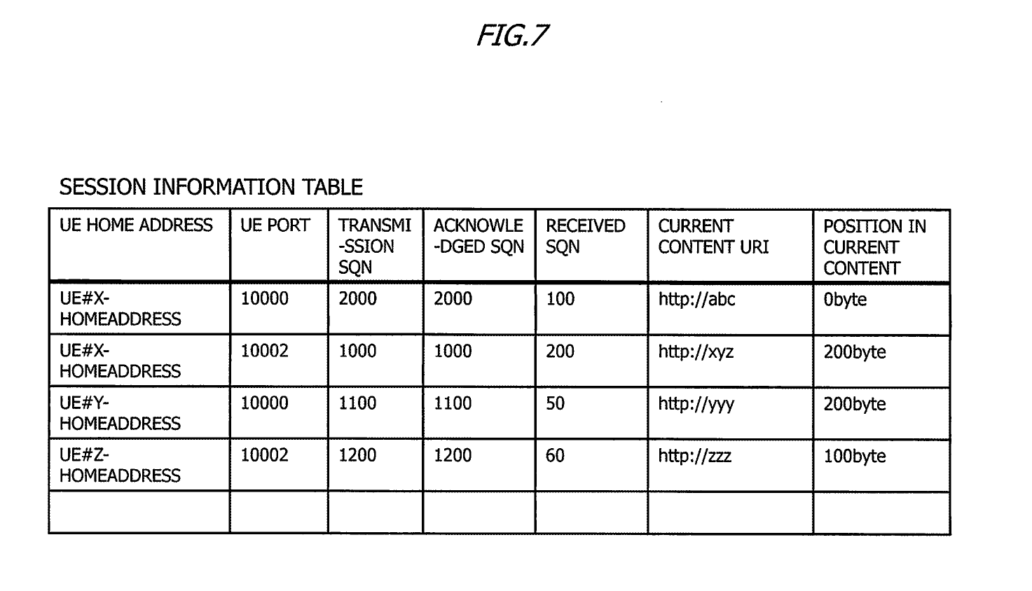

FIG. 7 is an example of the session information table. The session information table is a table for holding a state of the session established between the virtual proxy 2 and the mobile terminal registered in the communication destination registration table.

The session information table illustrated in FIG. 7 includes items of “UE Home Address”, “UE Port”, “Transmission Sequence Number (SQN)”, “Acknowledged Sequence Number (SQN)”, “Received Sequence Number (SQN)”, “Current Content URI”, and “Position in Current Content”.

The “UE Home Address” associates the records of the session information table with the records of the communication destination registration table.

The “UE Port” stores a port number on the mobile terminal side of the TCP communication session established between the mobile terminal and the virtual proxy 2. Since the mobile terminal is the sender of the session handled by the virtual proxy 2, the port number of the mobile terminal side is different in each session. Therefore, the session is specified by the home address and the port number of the mobile terminal.

The “Transmission SQN” stores a sequence number provided to a latest PDU (Protocol Data Unit) transmitted from the virtual proxy 2 to the mobile terminal. The “Acknowledged SQN” stores a sequence number for which an acknowledgment (TCP ACK) is already received from the mobile terminal, for the PDU transmitted from the virtual proxy 2 to the mobile terminal. The “Received SQN” stores a sequence number of the latest PDU received by the virtual proxy 2 from the mobile terminal.

The “Current Content URI” stores an identifier of the content requested from the mobile terminal in relation to the corresponding TCP session. In the example illustrated in FIG. 7, a URI (Uniform Resource Identifier) of the content is stored as the identifier of the content.

The “Position in Current Content” stores a current position of the distribution completion from the top of the content requested from the mobile terminal in relation to the corresponding TCP session. For example, if the “Position in Current Content” is 0 byte, the content is not transmitted yet. For example, if the “Position in Current Content” is 200 bytes, the transmission from the top to the 200th byte of the content is completed.

The example illustrated in FIG. 7 indicates that two sessions are established between the virtual proxy 2 in the cache server 1 and the mobile terminal with the home address “UE#x-HomeAddress”, wherein the port numbers on the mobile terminal side are “10000” and “10002”. Although it is assumed in the first embodiment that one virtual proxy is prepared for one mobile terminal and that a plurality of sessions are used between one virtual proxy and one mobile terminal, the configuration is not limited to this. For example, the virtual proxy may be prepared for each session.

The virtual proxy processing unit 13 creates the records of the session information table at the establishment of the first communication session in the first embodiment. Furthermore, the virtual proxy processing unit 13 updates the corresponding record every time a PDU of TCP is received and transmitted. When the communication session is disconnected, the virtual proxy processing unit 13 deletes the corresponding record of the session information table.

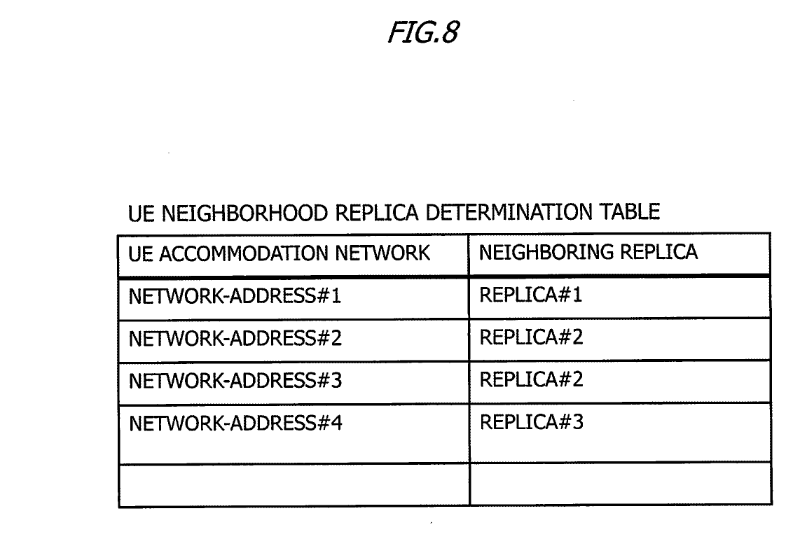

FIG. 8 is an example of the UE neighborhood Replica determination table. The UE neighborhood Replica determination table is a table storing an association between the network address and the Replica covering the network address.

The UE neighborhood Replica determination table illustrated in FIG. 8 includes items of “UE Accommodation Network” and “Neighboring Replica”. The network address in the content distribution system 100 is stored in the “UE Accommodation Network”. The identification information of the Replica located near the corresponding network address is stored in the “Neighboring Replica”. For example, the address of the Replica may be stored as the identification information of the Replica.

The UE neighborhood Replica determination table is registered in advance by installing the content distribution program or is registered in advance by the manager of the content distribution system 100, for example.

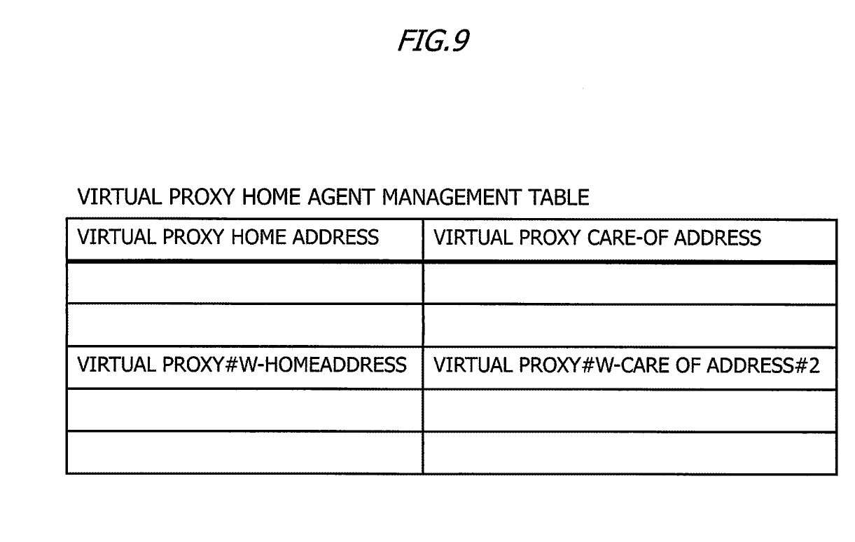

FIG. 9 is an example of the virtual proxy home agent management table 17. The virtual proxy home agent management table 17 is a table storing an association between the home address and the care-of address of the virtual proxy 2 that handles the link connecting the cache server 1 as the home link.

The virtual proxy home agent management table 17 illustrated in FIG. 9 includes items of “Virtual Proxy Home Address” and “Virtual Proxy Care-of Address”. The virtual proxy 2 does not have the care-of address when connected to the home link and has the care-of address when connected to a foreign link. Therefore, the virtual proxy 2 moved from the link connecting the cache server 1 (home link for the virtual proxy 2) to another link (foreign link for the virtual proxy 2) is registered in the virtual proxy home agent management table 17.

The tables illustrated in FIGS. 6 to 9 are illustrative, and the data structures of the tables are not limited to the examples illustrated in FIGS. 6 to 9.

(Flow of Process)

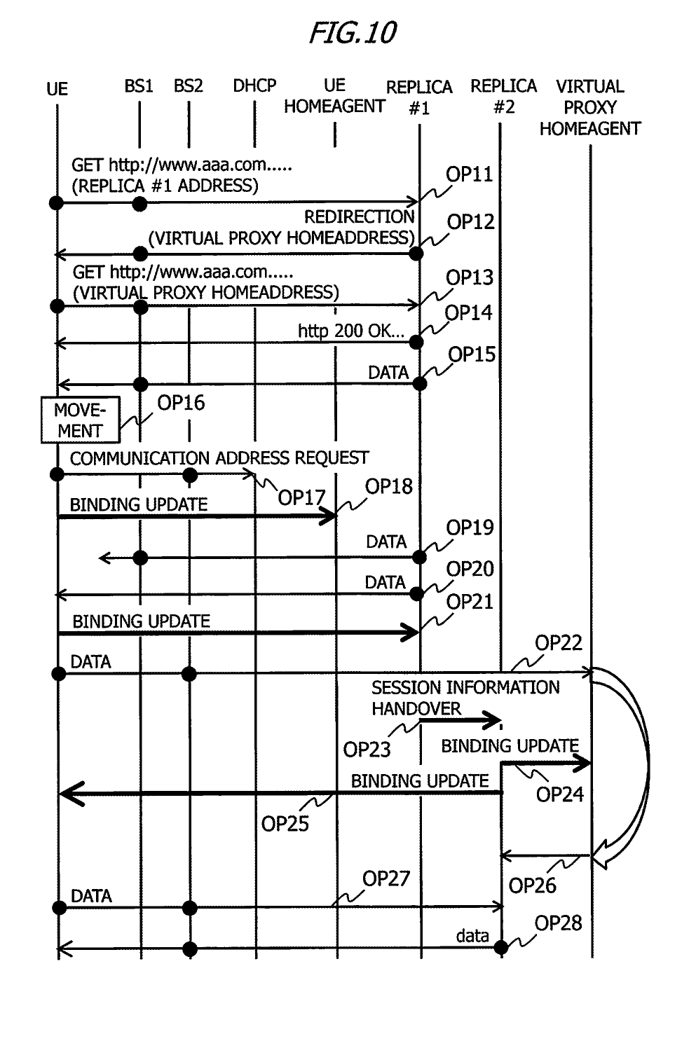

FIG. 10 is a diagram illustrating an example of a processing sequence in the content distribution system 100 according to the first embodiment. The example illustrated in FIG. 10 indicates a sequence in the content distribution system 100 illustrated in FIG. 3, from the establishment of the communication session between the mobile terminal 4 and the Replica #1 to the movement of the mobile terminal 4 and the corresponding completion of the movement of the virtual proxy 2. In the example illustrated in FIG. 3, it is assumed that the communication session is an HTTP session. However, the communication session established between the mobile terminal 4 and the Replica in the content distribution system 100 is not limited to HTTP. The communication session established between the mobile terminal 4 and the Replica in the content distribution system 100 may be communication based on TCP, such as FTP (File Transfer Protocol) and HTTP, in a service intended to distribute the content to a plurality of viewers or may be communication based on UDP of unicast, such as TFTP (Trivial File Transfer Protocol).

Note that a BS1 and a BS2 in FIG. 10 denote base stations connected by the mobile terminal before the movement and after the movement, respectively. In FIG. 10, the mobile terminal 4 is connected to the BS1 in the initial state.

In OP11, the mobile terminal 4 transmits an HTTP GET message. The HTTP GET message is transmitted with the address of the Replica #1 as the destination address. Furthermore, in FIG. 10, the HTTP GET message is a connection request received first by the Replica #1 from the mobile terminal 4.

Although not illustrated in FIG. 10, the mobile terminal 4 accesses a DNS (Domain Name System) server before the transmission of the HTTP GET message of OP11 and acquires the address of the Replica #1 corresponding to the URL of the access destination based on name resolution.

The Replica #1 receives the HTTP GET message from the mobile terminal 4 to create the virtual proxy 2 for the mobile terminal 4.

In OP12, the Replica #1 returns an HTTP redirection message to the mobile terminal 4. The HTTP redirection message is a message for notifying the movement of the URL. The mobile terminal 4 is notified of the home address of the virtual proxy 2 in the Replica #1 through the HTTP redirection message.

In OP13, the mobile terminal 4 transmits the HTTP GET message by handling the home address of the virtual proxy 2 notified by the HTTP redirection message as the destination address.

In OP14, the Replica #1 serves as the virtual proxy 2 to transmit a response message of the HTTP GET message to the mobile terminal 4. When OP14 is completed, the communication session between the mobile terminal 4 and the virtual proxy 2 in the Replica #1 is established.

In OP15, the Replica #1 serving as the virtual proxy 2 transmits the requested content to the mobile terminal 4. If the requested content is not stored in the Web cache 14 of the Replica #1, the Replica #1 downloads the corresponding content from the Replica #Master and transmits the content to the mobile terminal 4.

In OP16, it is assumed that the mobile terminal 4 is moved and that there is a handover from the BS1 to the BS2. Furthermore, it is assumed that the link connecting the mobile terminal 4 is also changed due to the movement to the cover range of the BS2.

In OP17, the mobile terminal 4 accesses a predetermined DHCP server (not illustrated in FIG. 3) and acquires a care-of address in the link at the movement destination.

In OP18, since the mobile terminal 4 has newly acquired the care-of address, the mobile terminal 4 transmits BU to the terminal home agent 5. Furthermore, since the BU is also transmitted to the communication partner in the Mobile IP, the mobile terminal 4 also transmits the BU to the Replica #1 as the virtual proxy 2 being the communication partner in OP21. The correspondence between the home address of the mobile terminal 4 and the care-of address in the link at the movement destination is included in the BU. Which one of the terminal home agent 5 and the Replica #1 first receives the BU transmitted by the mobile terminal 4 is heavily dependent on the network environment, and the BU may not always first reach the terminal home agent 5 as illustrated in FIG. 10.

The content from the Replica #1 as the virtual proxy 2 is also distributed during the movement of the mobile terminal 4. OP19 and OP20 illustrate data transmission performed by the Replica #1 before the BU from the mobile terminal 4 reaches.

In OP19 and OP20, since the care-of address of the movement destination of the mobile terminal 4 is not acquired, the Replica #1 still transmits data to the home address of the mobile terminal 4. In OP19, although the data goes through the BS1, the mobile terminal 4 as the destination is not under the control of the BS1, and this data transmission ends in a failure.

Data transmission from the Replica #1 in OP20 is retransmission of the data transmission in OP19. In OP20, the terminal home agent 5 has received the BU and acquired a new care-of address of the mobile terminal 4. Therefore, in OP20, the data to the home address of the mobile terminal 4 is transferred to the terminal home agent 5, and the terminal home agent 5 forwards the data to the new care-of address of the mobile terminal 4.

Subsequently, data transmitted from the mobile terminal 4 and data transmitted to the mobile terminal 4 go through the BS2.

In OP23, since the BU is received from the mobile terminal 4 in OP21, the Replica #1 detects the Replica #2 as a Replica near the mobile terminal 4 based on the care-of address at the movement destination of the mobile terminal 4. The Replica #1 transmits information related to the communication session with the mobile terminal 4 to the Replica #2. Specifically, the Replica #1 transmits the records corresponding to the mobile terminal 4 in the communication destination registration table and the session information table to the Replica #2. When the records are received, the Replica #2 registers the records in the communication destination registration table and the session information table. As a result, the virtual proxy 2 moves from the Replica #1 to the Replica #2. However, at this stage, the mobile terminal 4 still recognizes that “there is a session with the Replica #1”.

In OP24 and OP25, since the virtual proxy 2 has moved, the Replica #2 as the virtual proxy 2 acquires the care-of address of the virtual proxy 2 and transmits the BU to the virtual proxy home agent 3 and the mobile terminal 4 as the communication partner. The mobile terminal 4 receives the BU from the Replica #2, and hereafter, the mobile terminal 4 acquires the care-of address of the virtual proxy 2 and transmits packets with the care-of address as the destination. As a result, the session with the Replica #1 moves to the Replica #2.

OP22 is transmission of data from the mobile terminal 4 to the virtual proxy 2 performed before the completion of the movement of the virtual proxy 2 to the Replica #2. At the stage of OP22, since the care-of address of the movement destination of the virtual proxy 2 is not acquired, the mobile terminal 4 transmits data to the home address of the virtual proxy 2. Therefore, the data is transferred to the virtual proxy home agent 3 that is the home agent of the virtual proxy 2. However, since the virtual proxy home agent 3 does not know the address of the movement destination of the virtual proxy 2 at the point of OP22, the data is not forwarded to the virtual proxy 2. For example, the virtual proxy home agent 3 temporarily buffers the data to the virtual proxy 2.

After the reception of the BU from the virtual proxy 2 in OP24, the virtual proxy home agent 3 acquires the care-of address of the movement destination of the virtual proxy 2. Subsequently, the virtual proxy home agent 3 can forward the data to the virtual proxy 2.

In OP26, the virtual proxy home agent 3 transmits, to the Replica #2 at the movement destination of the virtual proxy 2, the data to the virtual proxy 2 buffered in OP22 and the data transmitted from the mobile terminal 4 with the home address of the virtual proxy 2 as the destination. The transfer of the data from the virtual proxy home agent 3 to the Replica #2 at the movement destination of the virtual proxy 2 is performed by using the IP in IP tunnel according to the specifications of the Mobile IP.

Meanwhile, in OP25, the mobile terminal 4 can transmit the data to the care-of address of the virtual proxy 2 by receiving the BU from the Replica #2 as the virtual proxy 2. In OP27 and OP28, since the mobile terminal 4 and the Replica #2 as the virtual proxy 2 know the care-of addresses of each other, the data is transmitted to the care-of address.

(Examples of Packets)

Next, examples of transmitted and received packets will be described according to the flow of the example of the sequence illustrated in FIG. 10.

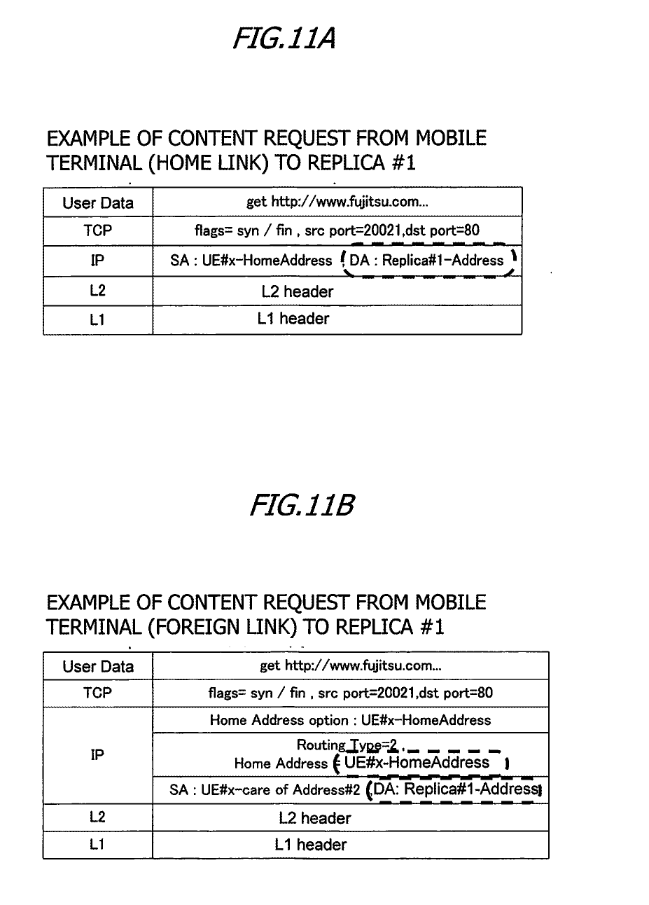

FIG. 11A is a diagram illustrating an example of the HTTP GET message transmitted from the mobile terminal 4 to the address of the Replica #1 in OP11 of FIG. 10. FIG. 11A illustrates an HTTP GET message when the mobile terminal 4 handles the link connecting the Replica #1 as the home link. Since it is assumed that the mobile terminal 4 handles the link connecting the Replica #1 as the home link in the sequence described in FIG. 10, the HTTP GET message illustrated in FIG. 11A is transmitted in OP11. The transmission source address of the HTTP GET message in this case is the home address (UE#x-HomeAddress in FIG. 11A) of the mobile terminal 4. The destination address of the HTTP GET message is the address (“Replica#1-Address” in FIG. 11A) of the Replica #1.

FIG. 11B is a diagram illustrating an example of the HTTP GET message transmitted to the address of the Replica when the mobile terminal 4 handles the link connecting the Replica #1 as a foreign link. In this case, a field for storing the home address (Home Address=UE#x-HomeAddress in the IP header in FIG. 11B) of the mobile terminal 4 is arranged in the IP header of the HTTP GET message. Furthermore, the transmission source address of the HTTP GET message in this case is the care-of address (UE#x-care of Address) of the mobile terminal 4.

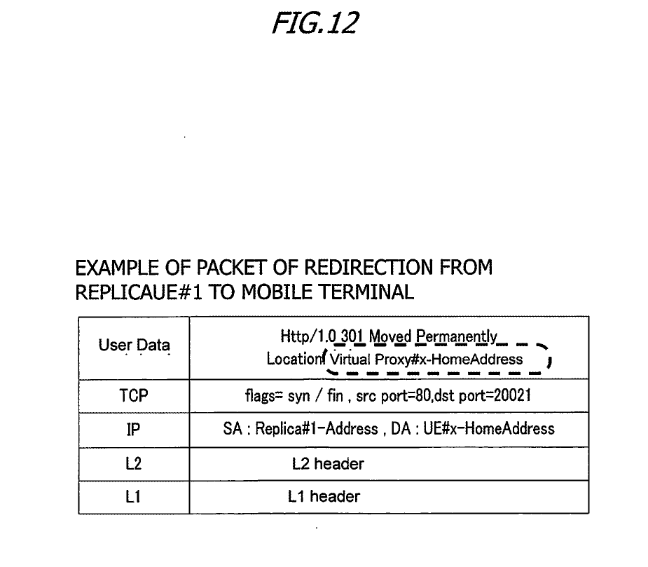

FIG. 12 is a diagram illustrating an example of the packet of the HTTP redirection transmitted from the Replica #1 to the mobile terminal 4 in OP12 of FIG. 10. A Location field in user data is a field storing the movement destination of the URL, and the home address (VirtualProxy#x-HomeAddress) of the virtual proxy 2 is stored in FIG. 12. The mobile terminal 4 is notified of the home address of the virtual proxy 2 in the Replica #1 through the HTTP redirection message.

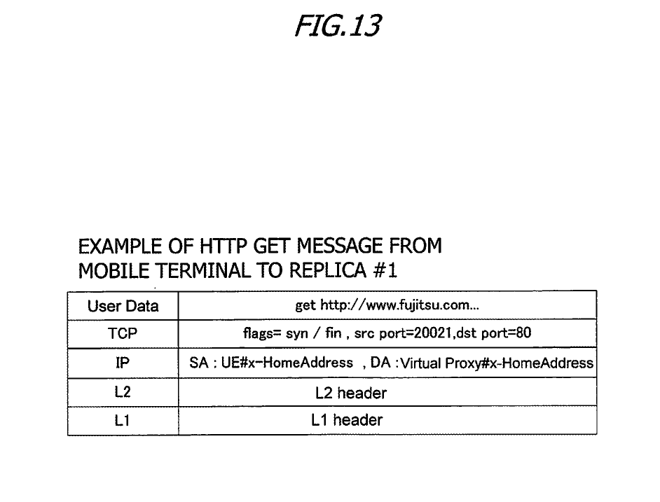

FIG. 13 is a diagram illustrating an example of the HTTP GET message transmitted from the mobile terminal 4 to the Replica #1 in OP13 of FIG. 10. In OP13 of FIG. 10, since the mobile terminal 4 has acquired the home address of the virtual proxy 2 in the Replica #1, the destination address of the HTTP GET message is the home address (VirtualProxy#x-HomeAddress) of the virtual proxy 2. The transmission source address of the HTTP GET message is the home address (UE#x-HomeAddress) of the mobile terminal 4 as in FIG. 11A.

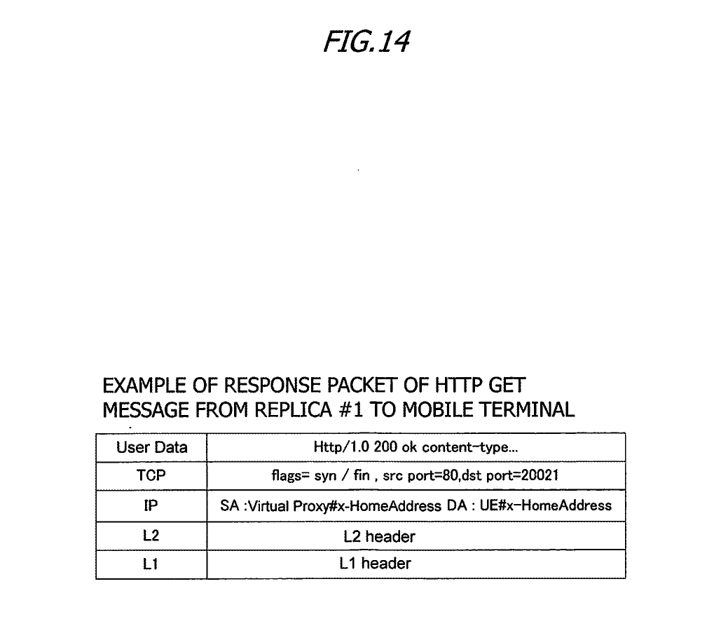

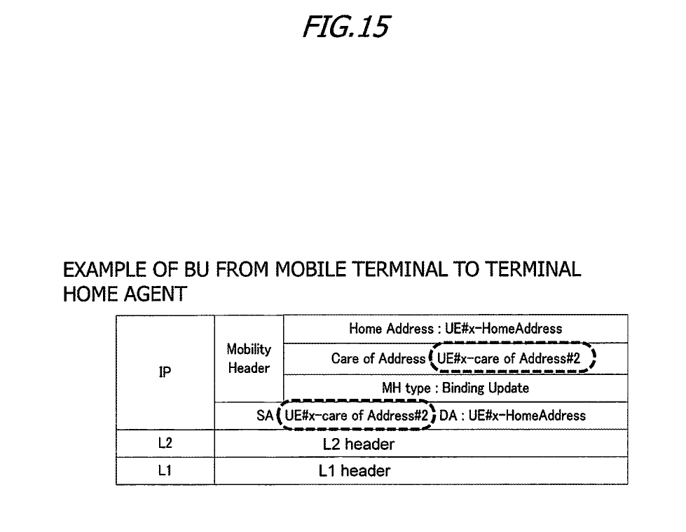

FIG. 14 is a diagram illustrating an example of the response packet of the HTTP GET message transmitted from the Replica #1 to the mobile terminal 4 in OP14 of FIG. 10. The transmission source address is the home address (VirtualProxy#x-HomeAddress) of the virtual proxy 2 in the Replica #1, and the destination address is the home address (UE#x-HomeAddress) of the mobile terminal 4.

FIG. 15 is a diagram illustrating an example of the BU transmitted from the mobile terminal 4 to the terminal home agent 5 in OP18 of FIG. 10. In OP18 of FIG. 10, since the mobile terminal 4 has moved to the link connecting the Replica #2 that is a foreign link and has acquired the care-of address, the care-of address (UE#x-care of Address#2) of the mobile terminal 4 acquired at the movement destination is stored in a “care of address” field of the BU. Furthermore, also in the transmission source address of the BU, the care-of address (UE#x-care of Address#2) of the mobile terminal 4 in the link at the movement destination is stored.

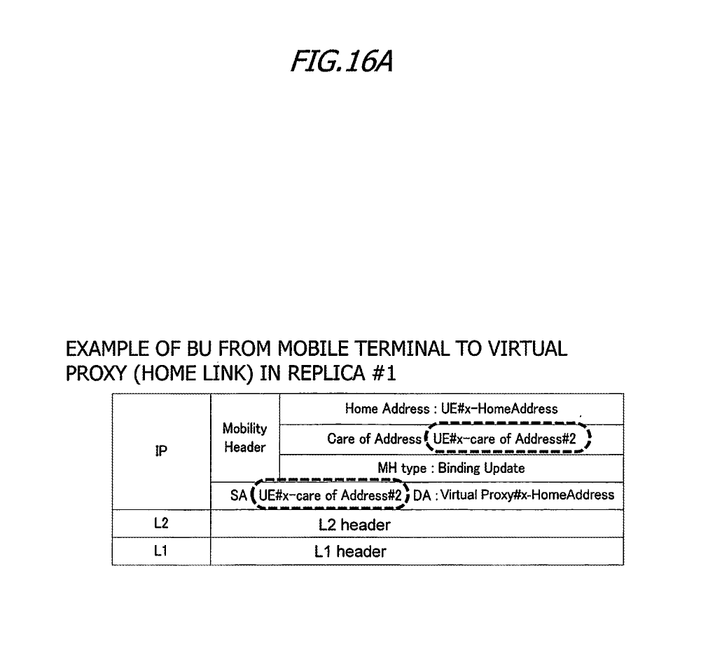

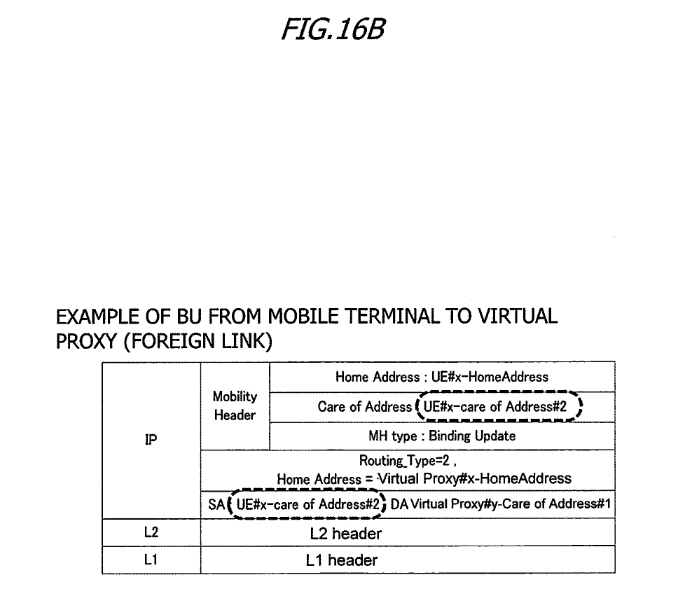

FIG. 16A is a diagram illustrating an example of the BU transmitted from the mobile terminal 4 to the virtual proxy 2 in the Replica #1 that is establishing a session in OP21 of FIG. 10. In the BU, the care-of address (UE#x-care of Address#2) of the mobile terminal 4 acquired at the movement destination is also stored in the “care of address” field in the IP mobile header. Furthermore, the care-of address (UE#x-care of Address#2) of the mobile terminal 4 in the link at the movement destination is also stored for the transmission source address of the BU. The destination address of the BU is the home address (VirtualProxy#x-Home Address) of the virtual proxy 2 in the Replica #1. Note that the example illustrated in FIG. 16A is an example when the virtual proxy 2 in the Replica #1 handles the link connecting the Replica #1 as the home link.

FIG. 16B is a diagram illustrating an example of a packet of the BU transmitted from the mobile terminal 4 to the virtual proxy 2 in the Replica that is establishing a session. However, the example illustrated in FIG. 16B is an example when the virtual proxy 2 in the Replica #1 that is establishing the session with the mobile terminal 4 handles the link connecting the Replica #1 as a foreign link. Therefore, the destination address of the BU illustrated in FIG. 16B is the care-of address of the virtual proxy 2 in the Replica #1 (VirtualProxy#y-care of Address#1).

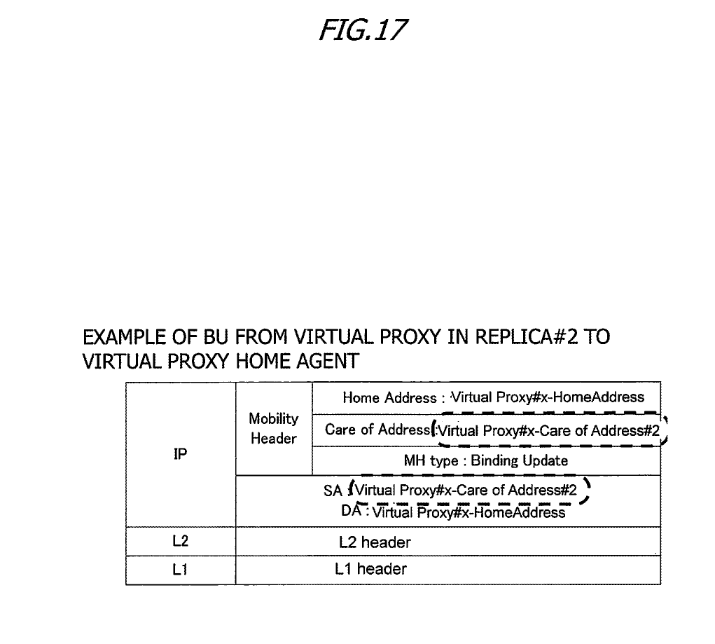

FIG. 17 is a diagram illustrating an example of the BU transmitted from the virtual proxy 2 in the Replica #2 to the virtual proxy home agent 3 in OP24 of FIG. 10. In OP24 of FIG. 10, since the virtual proxy 2 has moved from the Replica #1 to the Replica #2 and acquired the care-of address, the care-of address (VirtualProxy#x-care of Address#2) of the virtual proxy 2 acquired at the movement destination is stored in the “care of address” field in the Mobile IP header of the BU. Furthermore, the care-of address (VirtualProxy#x-care of Address#2) of the virtual proxy 2 in the link at the movement destination is also stored for the transmission source address of the BU.

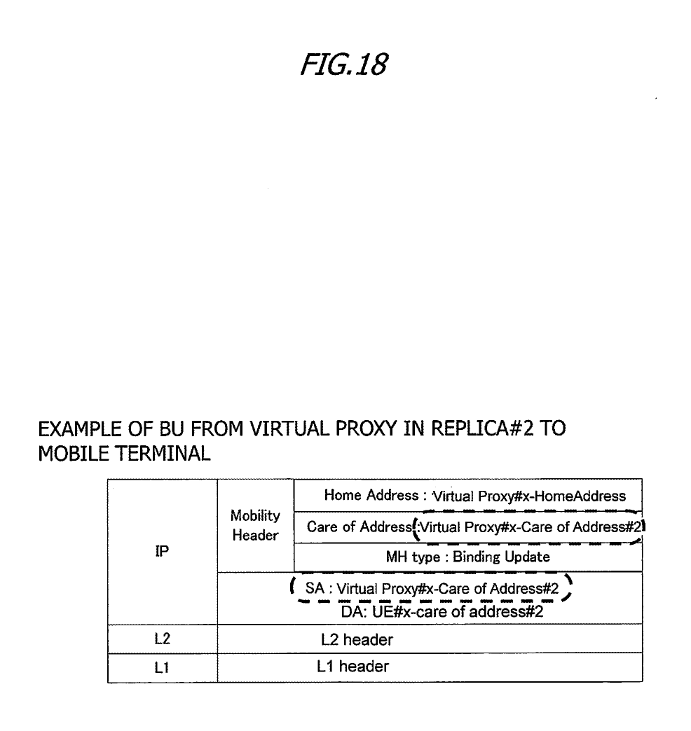

FIG. 18 is a diagram illustrating an example of the BU transmitted from the virtual proxy 2 in the Replica #2 to the mobile terminal 4 in OP25 of FIG. 10. In the BU packet, the care-of address (VirtualProxy#x-care of Address#2) of the virtual proxy 2 acquired at the movement destination is also stored in the “care of address” field in the Mobile IP header. Furthermore, the care-of address (VirtualProxy#x-care of Address#2) of the virtual proxy 2 in the link at the movement destination is also stored for the transmission source address of the BU.

(Internal Process)

Next, a flow of an internal process of the cache server 1 will be described according to the flow of the example of the sequence illustrated in FIG. 10.

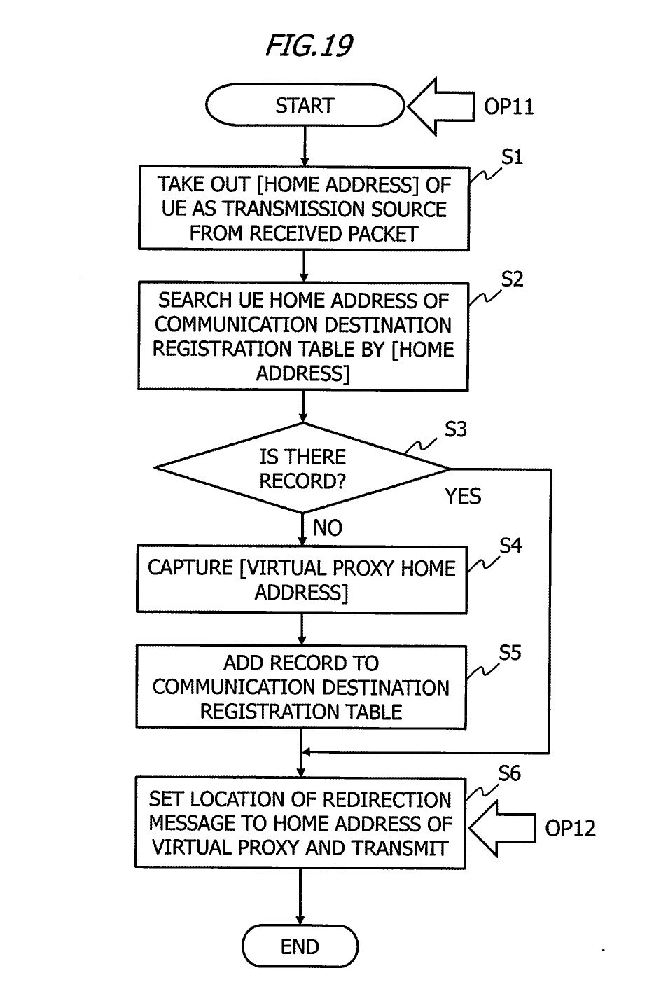

FIG. 19 is an example of a flow chart of a process by the virtual proxy processing unit 13 when the HTTP GET message to the address of the Replica is received. The flow chart illustrated in FIG. 19 is started in the Replica #1 when, for example, the proxy processing unit 13 receives the HTTP GET message to the address of the Replica #1 (see FIG. 11A) in OP11 of FIG. 10.

In S1, the virtual proxy processing unit 13 takes out the home address of the mobile terminal 4 from the received packet (HTTP GET message). If the link connecting the Replica #1 is the home link for the mobile terminal 4, the virtual proxy processing unit 13 takes out the home address of the mobile terminal 4 from the transmission source address of the HTTP GET message (see FIG. 11A). If the link connecting the Replica #1 is a foreign link for the mobile terminal 4, the virtual proxy processing unit 13 takes out the home address of the mobile terminal 4 from the HTTP GET message and takes out the care-of address of the mobile terminal 4 from the transmission source address (see FIG. 11B). Next, the process proceeds to S2.

In S2, the virtual proxy processing unit 13 searches the item of “UE Home Address” in the communication destination registration table based on the home address of the mobile terminal 4 taken out from the received packet (HTTP GET message) in S1. If there is no record matching the home address of the mobile terminal 4 taken out from the received packet (HTTP GET message) in S1 (S3: NO), the process proceeds to S4.

In S4, since the corresponding record does not exist in the communication destination registration table, that is, since the virtual proxy 2 for the mobile terminal 4 does not exist in the cache server 1, the virtual proxy processing unit 13 captures the home address of the virtual proxy 2 to create the virtual proxy 2. The home address of the virtual proxy 2 may be acquired from the DHCP server, for example. The cache server 1 may hold an address pool for the virtual proxy 2 in advance, and the home address may be acquired from an unused address in the address pool. Next, the process proceeds to S5.

In S5, the virtual proxy processing unit 13 adds records to the communication destination registration table. The home address of the mobile terminal 4 taken out in S1, the care-of address, and the home address of the virtual proxy 2 captured in S4 are stored in the items of “UE Home Address”, “UE Care-of Address”, and “Virtual Proxy Home Address”, respectively, of the records added in this case. Since the virtual proxy 2 exists in the home link, the “Virtual Proxy Care-of Address” of the record is empty. Furthermore, the “UE Care-of Address” is empty when the mobile terminal 4 handles the link connecting the cache server 1 as the home link. Next, the process proceeds to S6.

If there is a record matching the home address of the mobile terminal 4 taken out from the received packet (HTTP GET message) in S1 (S3: YES), there is a virtual proxy 2 that is establishing a communication session with the mobile terminal 4. In this case, since the record may not be added to the communication destination registration table, the process proceeds to S6.

In S6, the virtual proxy processing unit 13 returns the HTTP redirection message to the mobile terminal 4. The HTTP redirection message includes a Location field for storing the movement destination of the URL, and the virtual proxy processing unit 13 stores the home address of the virtual proxy 2 in the Location field (see FIG. 12). As a result, the mobile terminal 4 is notified of the home address of the virtual proxy 2. The process of S6 is equivalent to, for example, OP12 of FIG. 10. Subsequently, the process illustrated in FIG. 19 ends.

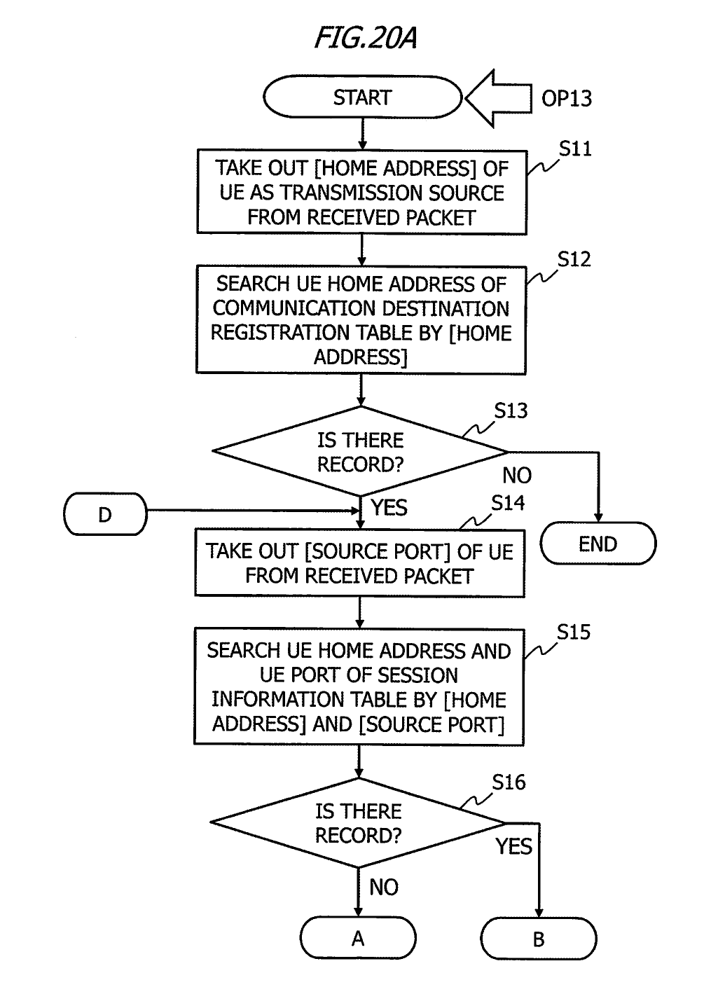

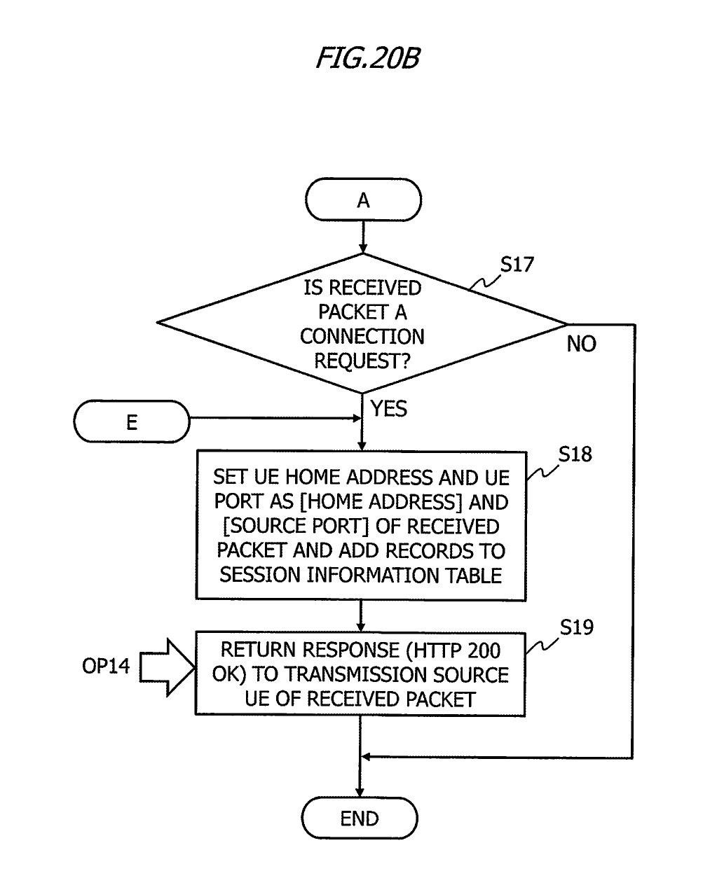

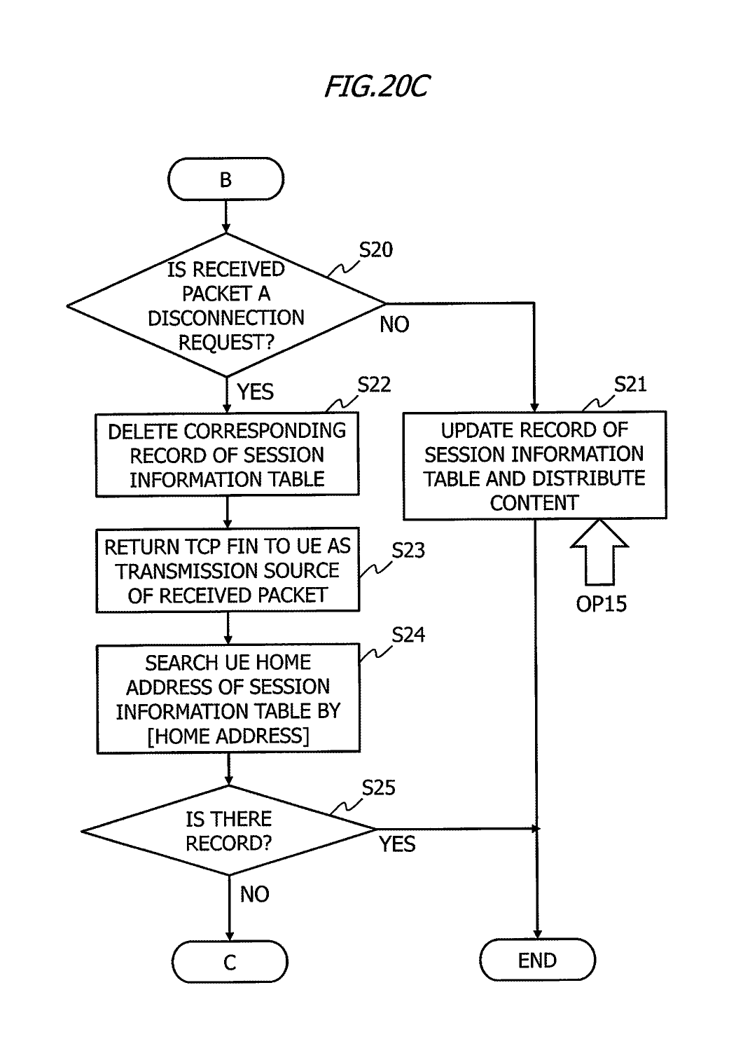

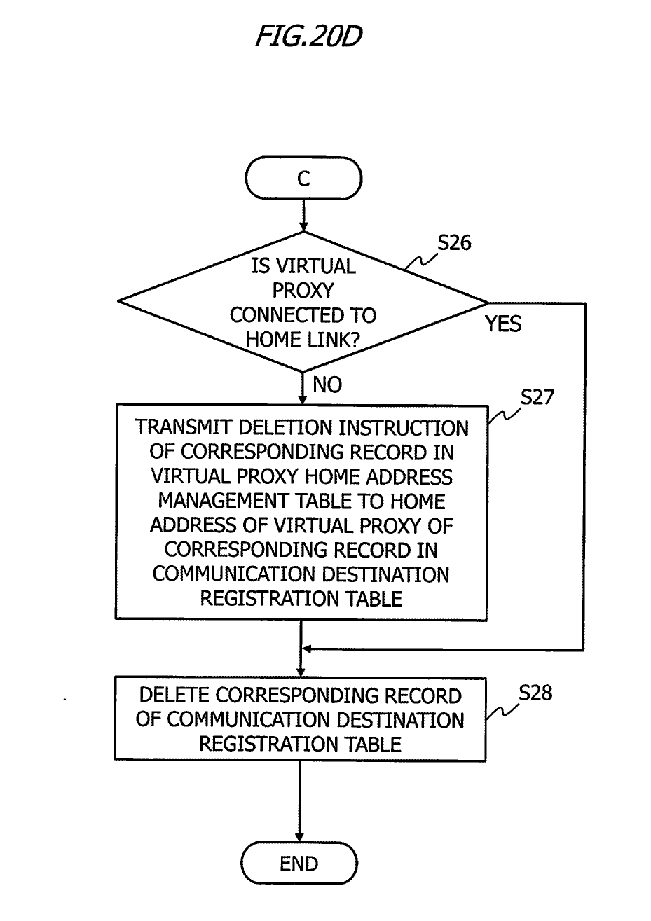

FIGS. 20A, 20B, 20C, and 20D illustrate an example of a flow chart of a process by the virtual proxy processing unit 13 when a TCP packet to the address of the virtual proxy in the Replica is received. The flow chart illustrated in FIG. 20A is started when, for example, the proxy processing unit 13 receives a TCP packet to the home address of the virtual proxy 2 in the cache server 1. The flow chart illustrated in FIG. 20A is also started in the Replica #1 when the Replica #1 receives the HTTP GET message from the mobile terminal 4 in OP13 of FIG. 10.

The processes of S11 to S13 are the same as S1 to S3 of FIG. 19. In S11, the virtual proxy processing unit 13 takes out the home address of the mobile terminal 4 from the received packet (TCP packet). In S12, the virtual proxy processing unit 13 searches the item of “UE Home Address” of the communication destination registration table based on the home address of the mobile terminal 4 taken out from the received packet in S11.

If there is a record matching the home address of the mobile terminal 4 taken out from the received packet in S11 (S13: YES), the process proceeds to S14. Since the record is registered in the communication destination registration table in the process illustrated in FIG. 19 executed before FIG. 20A, the process usually proceeds to S14.

If there is no record matching the home address of the mobile terminal 4 taken out from the received packet in S11 (S13: NO), the virtual proxy 2 as the destination of the received packet does not exist in the cache server 1, and the processes illustrated in FIGS. 20A to 20D end.

In S14, the port number of the transmission source is taken out from the received packet. The port number of the transmission source is the port number on the side of the mobile terminal 4 of the TCP session. Next, the process proceeds to S15.

In S15, the virtual proxy processing unit 13 searches the items of “UE Home Address” and “UE Port” of the session information table based on the home address of the mobile terminal 4 taken out from the received packet in S11 and the port number of the transmission source taken out from the received packet in S14. If there is a matching record (S16: YES), the process proceeds to S20. If there is no matching record (S16: NO), the process proceeds to S17.

In S17, the virtual proxy processing unit 13 determines whether the received packet is a connection request. The TCP packet of the connection request is a TCP SYN packet, and the HTTP GET message is one of the TCP SYN packets. If the received packet is a connection request (S17: YES), the process proceeds to S18. If the received packet is not a connection request (S17: NO), there is no corresponding record in the session information table, and the session is not established. Therefore, the processes illustrated in FIGS. 20A to 20D end.

In S18, the virtual proxy processing unit 13 adds the records to the session information table. The home address of the mobile terminal 4 taken out in S11 and the port number of the transmission source taken out in S14 are stored in the “UE Home Address” and the “UE Port”, respectively, of the records added in this case. The information of the items of other records is also extracted from the received packet and stored in the session information table. Next, the process proceeds to S19.

In S19, the virtual proxy processing unit 13 transmits a response to the mobile terminal 4 of the transmission source of the received packet (connection request). If the received packet is the HTTP GET message, the response is an HTTP 200 OK packet (see FIG. 14). Subsequently, the processes illustrated in FIGS. 20A to 20D end. The process of S19 is equivalent to, for example, OP14 of FIG. 10.

From S20 is a process when the communication destination registration table and the session information table include records corresponding to the mobile terminal 4 of the transmission source of the received packet. In S20, the virtual proxy processing unit 13 determines whether the received packet is a disconnection request. If the received packet is a disconnection request (S20: YES), the process proceeds to S22.

If the received packet is not a disconnection request (S20: NO), the received packet is a data packet because it is already determined that the session is established between the virtual proxy 2 and the mobile terminal 4. In this case, the process proceeds to S21.

In S21, since the received packet is a data packet, the virtual proxy processing unit 13 extracts the information from the received packet and updates the corresponding records in the session information table. For example, the virtual proxy processing unit 13 extracts the sequence number of the received packet and updates the corresponding items of “Transmission SQN”, “Acknowledged SQN”, and “Received SQN” of the session information records. Furthermore, the virtual proxy processing unit 13 transmits the next PDU of the content to the mobile terminal 4. Subsequently, the processes illustrated in FIGS. 20A to 20D end. The process of S21 is equivalent to, for example, the process of OP15 of FIG. 10.

In S22, since the received packet is a disconnection request, the virtual proxy processing unit 13 deletes the records in which the home address of the transmission source of the received packet and the port number of the transmission source coincide with the “UE Home Address” and the “UE Port” in the session information table. Next, the process proceeds to S23.

In S23, a TCP FIN packet is transmitted to the mobile terminal 4 of the transmission source of the received packet. As the mobile terminal 4 receives the TCP FIN packet, the communication session between the mobile terminal 4 and the virtual proxy 2 is disconnected. Next, the process proceeds to S24.

In S24, the virtual proxy processing unit 13 searches the item of “UE Home Address” in the session information table based on the home address of the mobile terminal 4 taken out from the received packet. S24 is a process of checking whether there is a session between the virtual proxy 2 and the mobile terminal 4, other than the session indicated by the record deleted in S22. If there is a record in which the item of “UE Home Address” matches the home address of the mobile terminal 4 (S25: YES), there is another session between the virtual proxy 2 and the mobile terminal 4. Therefore, the corresponding record of the communication destination registration table is not deleted, and the processes illustrated in FIGS. 20A to 20D end.

If there is no record in which the item of “UE Home Address” matches the home address of the mobile terminal 4 in the session information table (S25: NO), there is no session between the virtual proxy 2 and the mobile terminal 4. In this case, the virtual proxy 2 can be deleted. Therefore, S26 to S28 are processes of deleting the virtual proxy 2.

In S26, the virtual proxy processing unit 13 determines whether the virtual proxy 2 is connected to the home link from the corresponding record in the communication destination registration table. If the virtual proxy 2 is connected to the home link, the item of “Virtual Proxy Care-of Address” of the corresponding record in the communication destination registration table is empty. On the other hand, if the virtual proxy 2 is connected to the foreign link, the care-of address is stored in the item of “Virtual Proxy Care-of Address” of the corresponding record in the communication destination registration table. Therefore, whether the virtual proxy 2 is connected to the home link is determined by the presence or absence of a value of the item of “Virtual Proxy Care-of Address” of the corresponding record in the communication destination registration table.

If the virtual proxy 2 is connected to the foreign link (S26: NO), it is indicated that the virtual proxy 2 is moved from another link. In this case, records including the home address and the care-of address of the virtual proxy 2 exist in the virtual proxy home agent management table 17 of the virtual proxy home agent 3 that manages the virtual proxy 2. Therefore, in S27, the virtual proxy processing unit 13 transmits, to the home address of the virtual proxy 2, an instruction for deleting the records including the home address and the care-of address of the virtual proxy 2 of the virtual proxy home agent management table 17. The deletion instruction transmitted to the home address of the virtual proxy 2 reaches the virtual proxy home agent 3 that manages the virtual proxy 2, and the corresponding entries are deleted from the virtual proxy home agent management table 17. Next, the process proceeds to S28.

If the virtual proxy 2 is connected to the home link (S26: YES), there is no record of the virtual proxy 2 in the virtual proxy home agent management table 17 of the virtual proxy home agent 3 that manages the virtual proxy 2. Therefore, the process proceeds to S28.

In S28, the virtual proxy processing unit 13 deletes the record corresponding to the virtual proxy 2 from the communication destination registration table. As the corresponding record is deleted from the communication destination registration table, the virtual proxy 2 for the removable terminal 4 is deleted from the Replica. Subsequently, the processes illustrated in FIGS. 20A to 20D end.

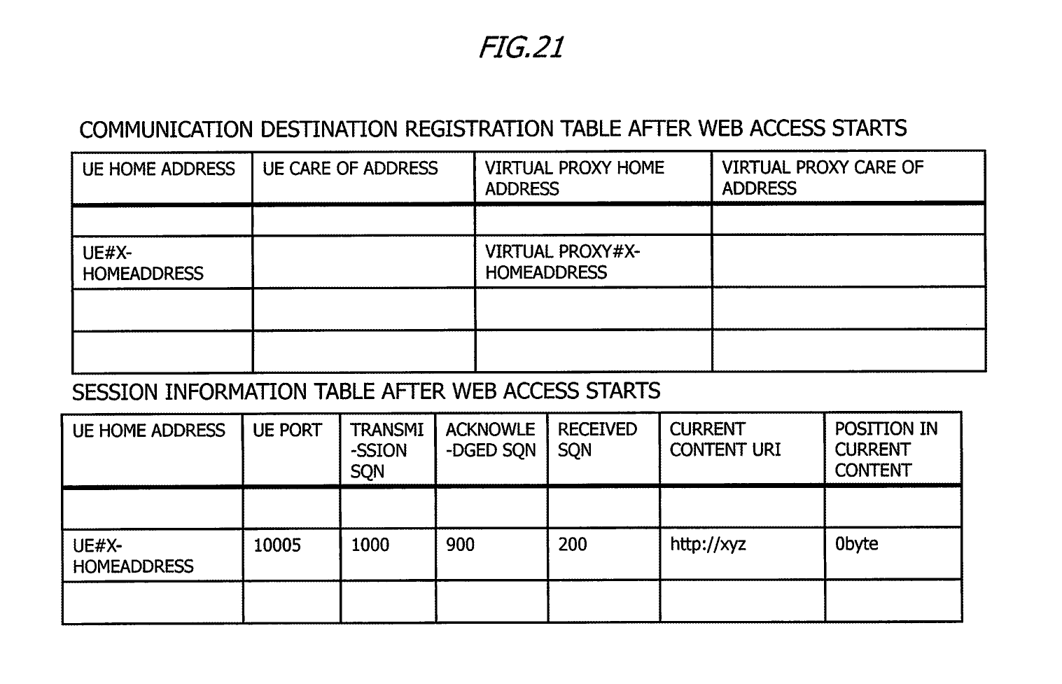

FIG. 21 is an example of the communication destination registration table and the session information table of the Replica #1 after the process of OP14 in FIG. 10. Since the Replica #1 creates the virtual proxy 2 in the example illustrated in FIG. 10, the virtual proxy 2 connects to the home link. Furthermore, in the example illustrated in FIG. 10, it is assumed that the mobile terminal 4 handles the link connecting the Replica #1 as the home link. Therefore, in the records of the communication destination registration table illustrated in FIG. 21, values are stored in the items of “UE Home Address” and “Virtual Proxy Home Address”, and values are not stored in the items of “UE Care-of Address” and “Virtual Proxy Care-of Address”.

Since the distribution of content is not started in OP14 of FIG. 10, the value of the item of “Position in Current Content” of the record in the session information table is “0 byte”.

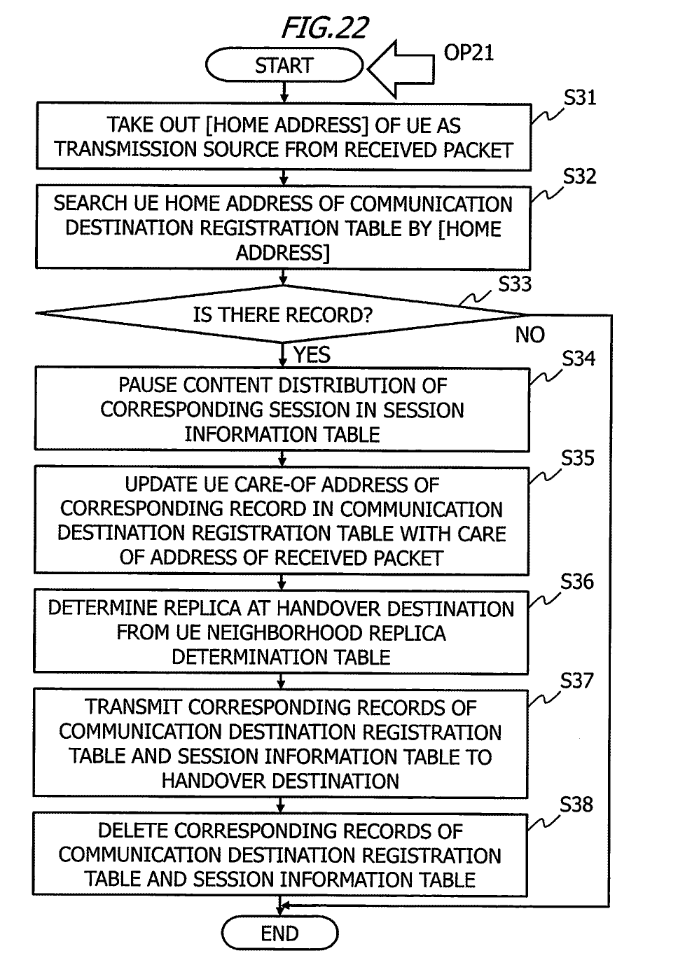

FIG. 22 is an example of a flow chart of a process by the virtual proxy processing unit 13 when the BU is received from the mobile terminal 4. The flow chart illustrated in FIG. 22 is started when, for example, the BU to the virtual proxy 2 in the cache server 1 is received. In OP21 of FIG. 10, the flow chart illustrated in FIG. 22 is also started in the Replica #1 when the Replica #1 receives the BU (see FIG. 16A) from the mobile terminal 4.

In S31, the virtual proxy processing unit 13 takes out the home address of the mobile terminal 4 of the transmission source from the received packet (BU) (see FIG. 16A). Next, the process proceeds to S32.

In S32, the virtual proxy processing unit 13 searches the item of “UE Home Address” in the communication destination registration table based on the home address of the mobile terminal 4 acquired in S31. If there is no record in which the value of the item of “UE Home Address” matches the home address of the mobile terminal 4 in the communication destination registration table (S33: NO), there is no session with the mobile terminal 4, and the process illustrated in FIG. 22 ends.

If there is a record in which the value of the item of “UE Home Address” matches the home address of the mobile terminal 4 (S33: YES), the movement of the mobile terminal 4 to another link is notified by the received packet (BU). Therefore, a process for moving the virtual proxy 2 that maintains the session with the mobile terminal 4 to a Replica located near the movement destination of the mobile terminal 4 is executed from the following S34. Hereinafter, the Replica as the movement destination of the virtual proxy 2 will be called a handover destination, because the session is moved along with the movement of the mobile terminal 4. Furthermore, the Replica of the movement source of the virtual proxy 4 will be called a handover source.

In S34, the virtual proxy processing unit 13 pauses all sessions in which the “UE Home Address” of the session information table matches the home address of the mobile terminal 4. Next, the process proceeds to S35.

In S35, the virtual proxy processing unit 13 updates the “UE Care-of Address” of the corresponding record in the communication destination registration table with the care-of address of the mobile terminal 4 in the received packet (BU). Next, the process proceeds to S36.

In S36, the virtual proxy processing unit 13 searches for a Replica closest to the movement destination of the mobile terminal 4. Specifically, the virtual proxy processing unit 13 searches the UE neighborhood Replica determination table based on the care-of address of the mobile terminal 4 in the received packet (BU) and detects a Replica near the movement destination of the mobile terminal 4. The detected Replica serves as the Replica at the handover destination. Next, the process proceeds to S37.

In S37, the virtual proxy processing unit 13 transmits the corresponding records of the communication destination registration table and the session information table to the Replica at the handover destination. The corresponding records of the communication destination registration table and the session information table are records in which the “UE Home Address” matches the home address of the mobile terminal 4 in the received packet (BU). Next, the process proceeds to S38. The process of S37 is equivalent to, for example, OP23 of FIG. 10.

In S38, the virtual proxy processing unit 13 deletes the corresponding records of the communication destination registration table and the session information table. As a result, the corresponding virtual proxy 2 is deleted from the Replica as a handover source. Subsequently, the process illustrated in FIG. 22 ends.

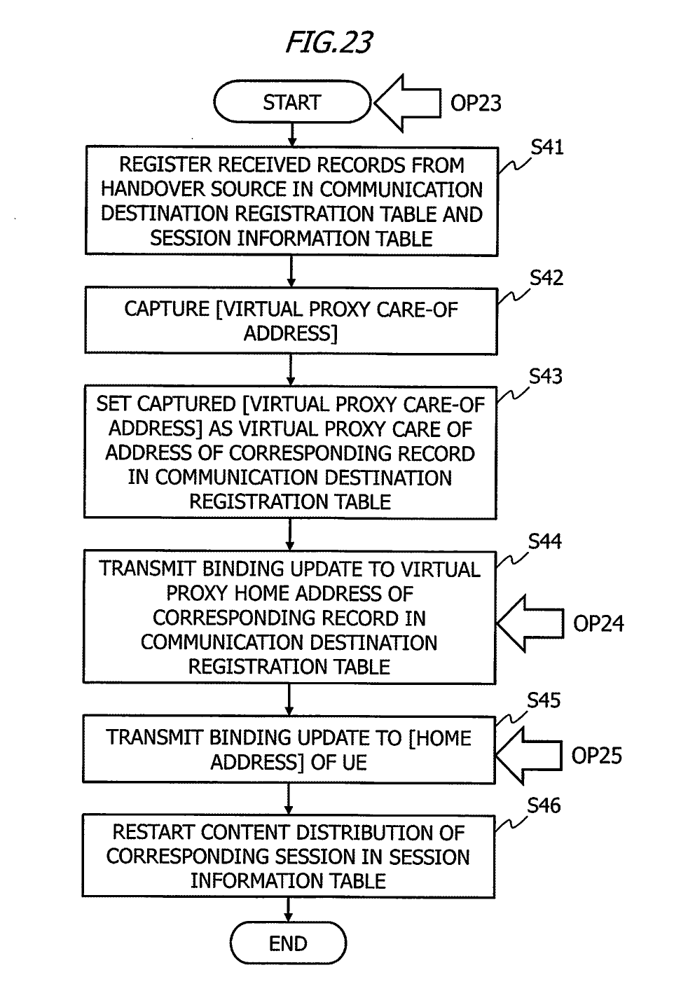

FIG. 23 is an example of a flow chart of a process by the virtual proxy processing unit 13 as a Replica at the handover destination when records of the communication destination registration table and the session information table are received from another Replica. The flow chart illustrated in FIG. 23 is started when the records of the communication destination registration table and the session information table are received from another Replica. The flow chart illustrated in FIG. 23 is also started in the Replica #2 if the Replica #2 receives the information of the session from the Replica #1 in OP23 of FIG. 10.

In S41, the virtual proxy processing unit 13 registers the records received from the Replica as the handover source in the communication destination registration table and the session information table. As a result, the movement of the virtual proxy 2 from the handover source to the handover destination is completed. Next, the process proceeds to S42.

In S42, since the virtual proxy 2 is moved to the foreign link, the virtual proxy processing unit 13 captures the care-of address of the virtual proxy 2. For example, the care-of address of the virtual proxy 2 is acquired from a predetermined DHCP server. Next, the process proceeds to S43.

In S43, the virtual proxy processing unit 13 stores the care-of address of the virtual proxy 2 acquired in S42 in the item of “Virtual Proxy Care-of Address” of the corresponding record in the communication destination registration table. Next, the process proceeds to S44.

In S44 and S45, since the virtual proxy 2 has newly acquired the care-of address, BU is transmitted to the virtual proxy home agent 3 that manages the virtual proxy 2 and to the mobile terminal 4 as the communication partner. The BU includes the correspondence between the home address of the virtual proxy 2 in the received record of the communication destination registration table and the care-of address of the virtual proxy 2 acquired in S42.

More specifically, in S44, the home address of the virtual proxy 2 of the received record in the communication destination registration table is handled as the destination, and the BU is transmitted to the virtual proxy home agent 3 that manages the virtual proxy 2. The process of S44 is equivalent to, for example, OP24 of FIG. 10. In S45, the address indicated by the “UE Care-of Address” of the received record in the communication destination registration table is handled as the destination, and the BU is transmitted to the mobile terminal 4 as the communication partner. The process of S45 is equivalent to, for example, OP25 of FIG. 10. Next, the process proceeds to S46.

In S46, the virtual proxy processing unit 13 uses the received record of the session information table to restart the session with the mobile terminal 4 to restart the content distribution. For example, the “UE Port” of the corresponding record in the session information table is used as the port number on the side of the mobile terminal 4, and the following sequence number of the “Transmission SQN” or the like and the content data started from a position following the position indicated by the “Position in Current Content” are used to restart the session with the mobile terminal 4. Subsequently, the process illustrated in FIG. 23 ends.

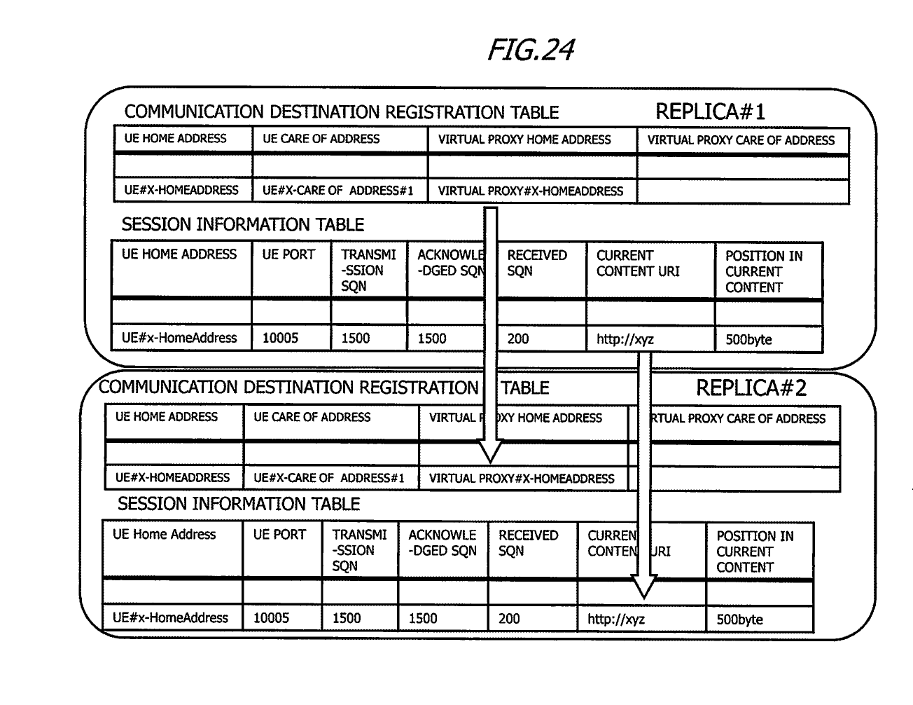

FIG. 24 is an example of the communication destination registration tables and the session information tables of the Replica #1 and the Replica #2 after the process of OP23 in FIG. 10. The corresponding records of the communication destination registration table and the session information table in the Replica #1 are copied to the communication destination registration table and the session information table of the Replica #2. Subsequently, the corresponding records of the communication destination registration table and the session information table are deleted from the Replica #1.

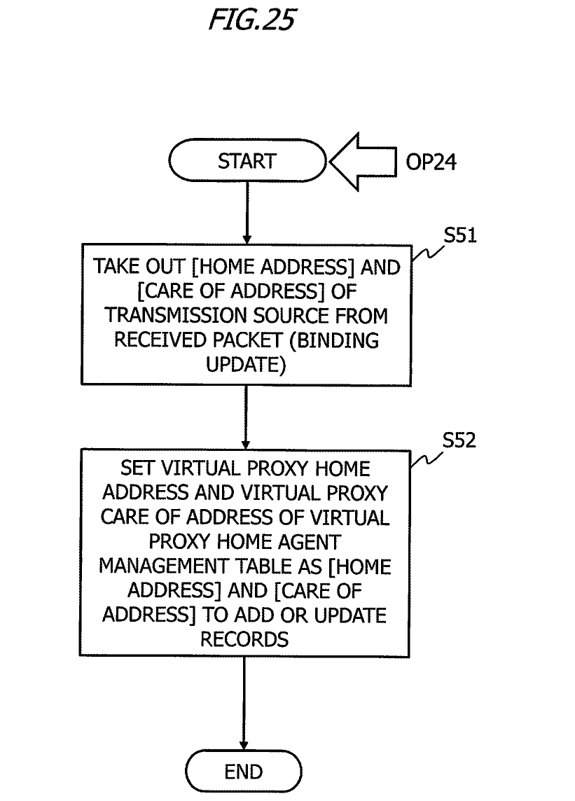

FIG. 25 is an example of a flow chart of a process by the virtual proxy home agent processing unit 16 as a virtual proxy home agent when the BU is received from the virtual proxy 2. The flow chart illustrated in FIG. 25 is started when the BU is received from the virtual proxy 2. The flow chart illustrated in FIG. 25 is also started in the Replica #1 including the virtual proxy home agent 3 when the virtual proxy home agent 3 receives the BU (see FIG. 15) from the virtual proxy 2 moved in the Replica #2 in OP24 of FIG. 10.

In S51, the virtual proxy home agent processing unit 16 takes out the home address and the care-of address of the virtual proxy 2 as the transmission source from the received packet (BU) (see FIG. 15). Next, the process proceeds to S52.

In S52, if there is a corresponding record of the virtual proxy home agent management table 17, the virtual proxy home agent processing unit 16 updates the item of “Virtual Proxy Care-of Address” with the care-of address of the virtual proxy 2 as the transmission source taken out from the received packet (BU). If there is no corresponding record of the virtual proxy home agent management table 17, the home address and the care-of address of the virtual proxy 2 as the transmission source taken out from the received packet (BU) are set for the items of “Virtual Proxy Home Address” and “Virtual Proxy Care-of Address” of a record, and the record is added. Subsequently, the process illustrated in FIG. 25 ends.

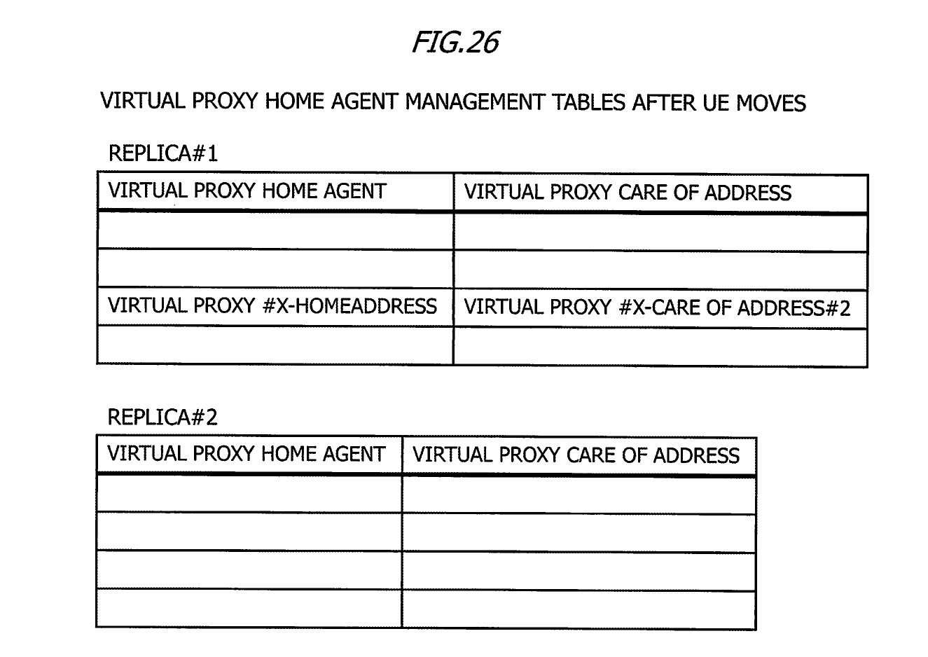

FIG. 26 is an example of the virtual proxy home agent management tables 17 of the Replica #1 and the Replica #2 after the process of OP24 in FIG. 10. In OP24 of FIG. 10, the virtual proxy home agent processing unit 16 in the Replica #1 executes the process illustrated in FIG. 25. Therefore, the home address (VirtualProxy#x-HomeAddress) of the virtual proxy 2 and the care-of address (VirtualProxy#x-care of Address#2) at the handover destination are stored in the virtual proxy home agent management table 17 in the Replica #1. On the other hand, the process illustrated in FIG. 25 is not generated in the virtual proxy home agent processing unit 16 in the Replica #2, and the initial state is maintained.

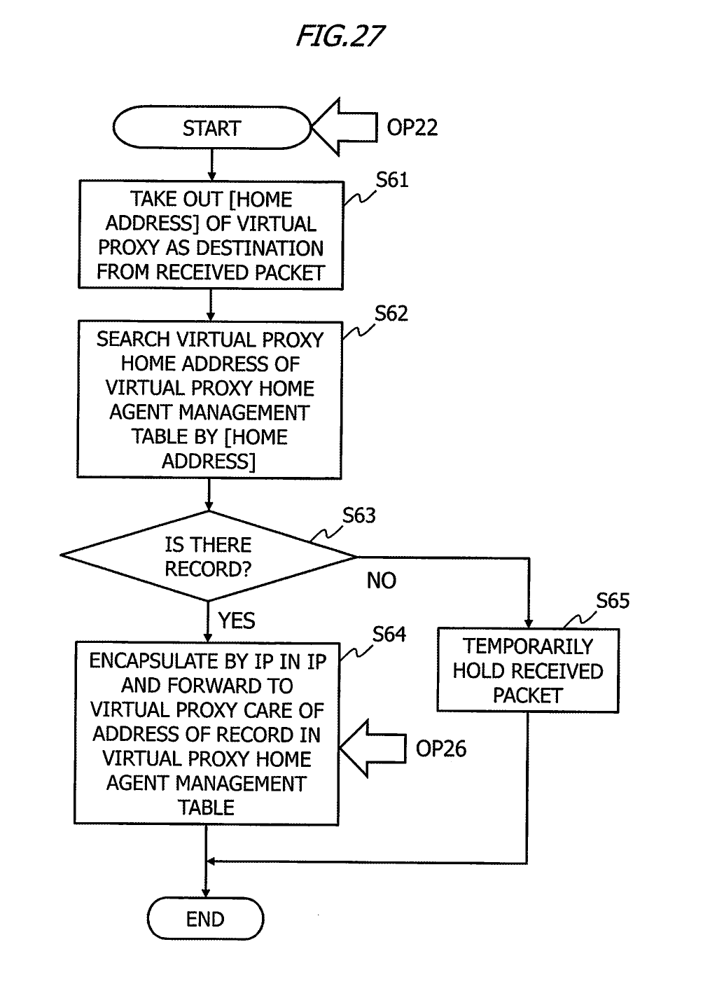

FIG. 27 is an example of a flow chart of a process by the virtual proxy home agent processing unit 16 as the virtual proxy home agent 3 when the TCP packet is received from the mobile terminal 4. The flow chart illustrated in FIG. 27 is started when the TCP data to the home address of the virtual proxy 2 managed by the virtual proxy home agent 3 is received from the mobile terminal 4. The flow chart illustrated in FIG. 27 is also started in the Replica #1 including the virtual proxy home agent 3 when the virtual proxy home agent 3 receives the data from the mobile terminal 4 moved to another link in OP22 of FIG. 10.

In S61, the virtual proxy home agent processing unit 16 takes out the home address of the virtual proxy 2 from the received packet (TCP packet). The home address of the virtual proxy 2 is stored as the destination address of the received packet (TCP packet). Next, the process proceeds to S62.

In S62, the virtual proxy home agent processing unit 16 searches the item of “Virtual Proxy Home Address” of the virtual proxy home agent management table 17 based on the home address of the virtual proxy 2 acquired from the received packet. If there is a record of the virtual proxy home agent management table 17 in which the value of the item of “Virtual Proxy Home Address” matches the home address of the virtual proxy 2 acquired from the received packet (S63: YES), the process proceeds to S64. If there is no record of the virtual proxy home agent management table 17 in which the value of the item of “Virtual Proxy Home Address” matches the home address of the virtual proxy 2 acquired from the received packet (S63: NO), the process proceeds to S65.

In S64, the virtual proxy home agent processing unit 16 forwards the received packet to the address of the item of “Virtual Proxy Care-of Address” of the corresponding record of the virtual proxy home agent management table 17. In this case, the received packet is encapsulated by IP in IP. The process of S64 is equivalent to, for example, the process of OP26 of FIG. 10. Subsequently, the process illustrated in FIG. 27 ends.

If the Replica as the virtual proxy 2 receives the packet encapsulated by IP in IP, the virtual proxy processing unit 13 of the Replica removes the capsule of the received packet to execute the same processes as those of FIGS. 20A to 20D, for example.

In S65, since the virtual proxy home agent processing unit 16 does not know the care-of address of the virtual proxy 2 as the forwarding destination of the received packet, the received packet is temporarily held in the buffer. Subsequently, the process illustrated in FIG. 27 ends. Note that the TCP packet temporarily held in the buffer is forwarded to the virtual proxy 2 by the IP in IP tunnel when, for example, the care-of address of the virtual proxy 2 is notified by the BU from the virtual proxy 2.

### Operation and Effects of First Embodiment

In the first embodiment, the virtual proxy that is establishing a session with the mobile terminal also moves to the cache server 1 near the movement destination of the mobile terminal in accordance with the movement of the mobile terminal. This can reduce increase in the amount of traffic flowing in the network of the content distribution system between the mobile terminal and the virtual proxy. As a result, the load in the network of the content distribution system can be reduced. According to the disclosed information processing device, content distribution method, and content distribution system, increase in the traffic in a network caused by movement of a mobile terminal in content distribution can be inhibited.

Furthermore, since the cache server 1 at the movement destination is also notified of the information related to the session established with the mobile terminal at the movement of the virtual proxy, the session from the movement source can be continued. The user of the mobile terminal can continuously receive the content before and after the movement of the mobile terminal without executing any operation for continuing the content distribution, and this is highly convenient.

Furthermore, in the first embodiment, the communication between the mobile terminal and the Replica is in accordance with the Mobile IP, and the existing Mobile IP can be utilized.

### Second Embodiment

In a second embodiment, the address of the cache server 1 is used for the home address and the care-of address of the virtual proxy 2 to reduce the addresses. In the second embodiment, the description common to the first embodiment will not be repeated.

In the second embodiment, the hardware configuration and the functional blocks of the cache server 1 are common to the first embodiment and are as illustrated in FIGS. 4 and 5.

(Data Structures)

In the second embodiment, since the address of the cache server 1 is used for the home address and the care-of address of the virtual proxy 2, the data structures of the tables are different from the first embodiment.

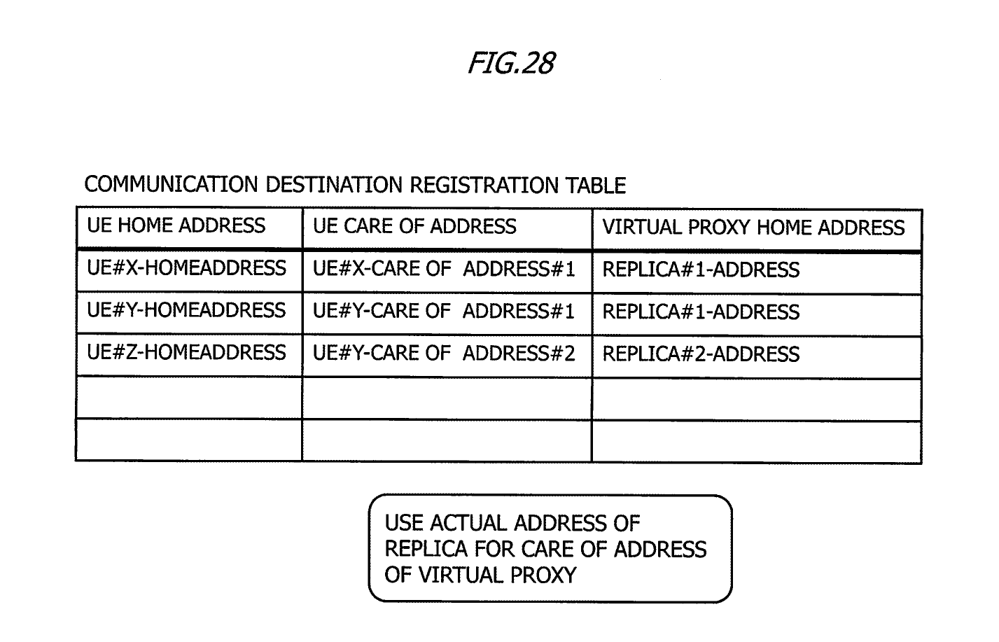

FIG. 28 is an example of the communication destination registration table according to the second embodiment. In the second embodiment, the records of the communication destination registration table include items of “UE Home Address”, “UE Care-of Address”, and “Virtual Proxy Home Address”. In the second embodiment, the address of the Replica is used for the care-of address of the virtual proxy 2, and this is because the Replica already recognizes the address of the Replica.

Furthermore, since the address of the Replica is used for the home address of the virtual proxy 2 in the second embodiment, the Replica of the creation source of the virtual proxy 2 can be identified by the address of the “Virtual Proxy Home Address” of the record in the communication destination registration table.

The communication destination registration table illustrated in FIG. 28 is a table of the Replica #1 in the content distribution system 100 of FIG. 3. The virtual proxy 2 of the record in which the “Virtual Proxy Home Address” is the address (Replica#1-Address) of the Replica #1 is created by the Replica #1 and connected to the home link.

The virtual proxy 2 of the record in which the “Virtual Proxy Home Address” is the address (Replica#2-Address) of the Replica #2 is created by the Replica #2 and connected to the foreign link. The care-of address of the virtual proxy 2 of the record serves as the address (Replica#1-Address) of the Replica #1.

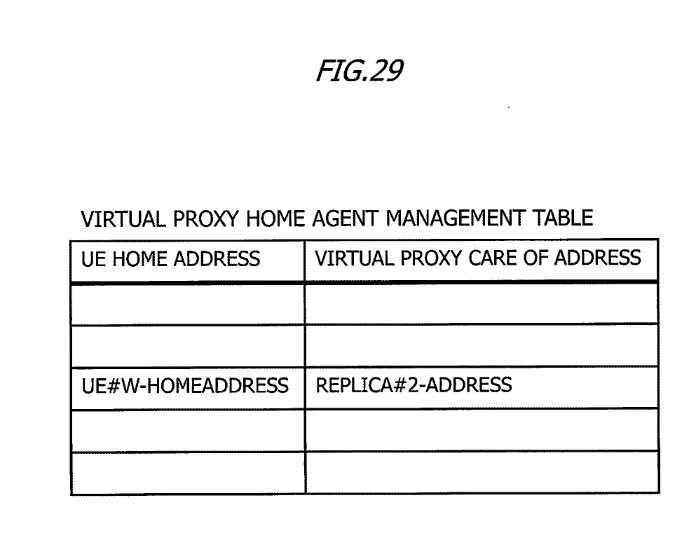

FIG. 29 is an example of the virtual proxy home agent management table 17 according to the second embodiment. In the first embodiment, the virtual proxy home agent 3 identifies the virtual proxy 2 to be connected to the foreign link by the home address and the care-of address. However, in the second embodiment, the home address of the virtual proxy 2 is the address of the Replica, and the virtual proxy 2 is not identified by the home address and the care-of address. Therefore, in the second embodiment, the virtual proxy home agent 3 identifies the virtual proxy 2 to be connected to the foreign link by the home address of the mobile terminal as the communication partner and the care-of address of the virtual proxy 2.

Therefore, in the second embodiment, the items of the records in the virtual proxy home agent management table 17 are the “UE Home Address” and the “Virtual Proxy Care-of Address”.

(Flow of Process)

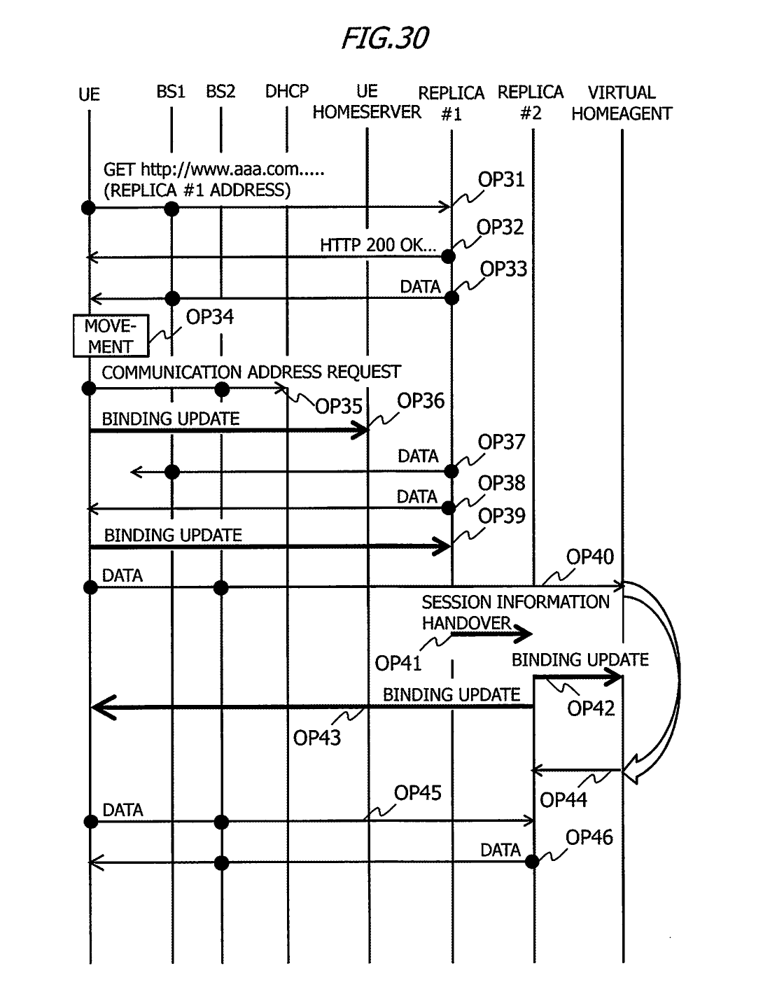

FIG. 30 is a diagram illustrating an example of a sequence of a process in the content distribution system 100 according to the second embodiment. As in FIG. 10 of the first embodiment, FIG. 30 illustrates a sequence from the establishment of the communication session between the mobile terminal 4 and the Replica #1 to the movement of the mobile terminal 4 and the corresponding completion of the movement of the virtual proxy 2 in the content distribution network illustrated in FIG. 3. The preconditions of the example illustrated in FIG. 30 are the same as those of the example illustrated in FIG. 10.

Compared to the sequence of the first embodiment illustrated in FIG. 10, the sequence of the second embodiment illustrated in FIG. 30 does not include the process of returning the HTTP redirection message to the HTTP GET message (OP11 and OP12 of FIG. 10). This is because the address of the Replica is used as the home address of the virtual proxy 2 in the second embodiment.

The destination of the HTTP GET message transmitted from the mobile terminal 4 in OP31 is the address of the Replica #1. This is because the mobile terminal 4 has acquired the address of the Replica #1 from the predetermined DNS server before OP31 (not illustrated in FIG. 30). When the HTTP GET message is received, the virtual proxy 2 that establishes a session with the mobile terminal 4 is created in the Replica #1. The home address of the virtual proxy 2 is the address of the Replica #1, and the address coincides with the destination of the HTTP GET message. Therefore, in OP32, the Replica #1 transmits the response message (HTTP 200 OK) of the HTTP GET message to the mobile terminal 4 instead of transmitting the HTTP redirection for notifying the mobile terminal 4 of the home address of the virtual proxy 2.

From OP33, the sequence is the same as the sequence from OP15 of FIG. 10. Therefore, the description of the processes from OP33 will not be repeated.

(Examples of Packets)

Examples of packets transmitted and received will be described according to the flow of the example of the sequence illustrated in FIG. 30. The packets common to the first embodiment will not be described.

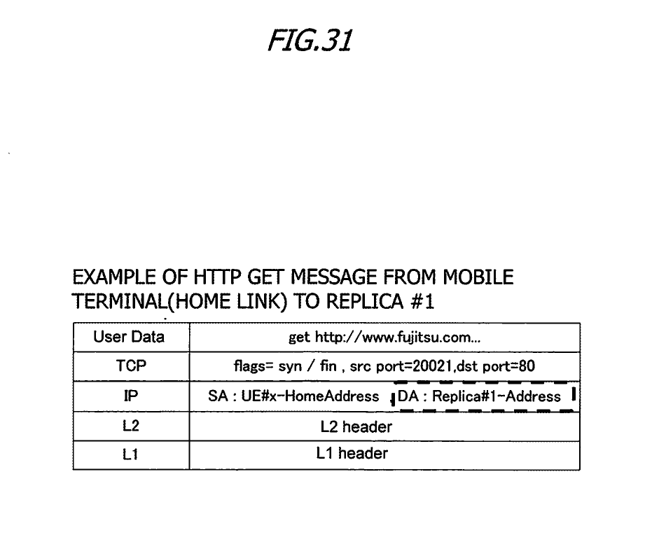

FIG. 31 is an example of the HTTP GET message transmitted from the mobile terminal 4 to the address of the Replica #1 in OP31 of FIG. 30. The destination address of the HTTP GET message is the address (Replica#1-Address) of the Replica #1. In OP31 of the sequence of FIG. 30, the mobile terminal 4 handles the link connecting the Replica #1 as the home link. Therefore, the transmission source address of the HTTP GET message of the example illustrated in FIG. 31 is the home address (UE#x-HomeAddress) of the mobile terminal 4.

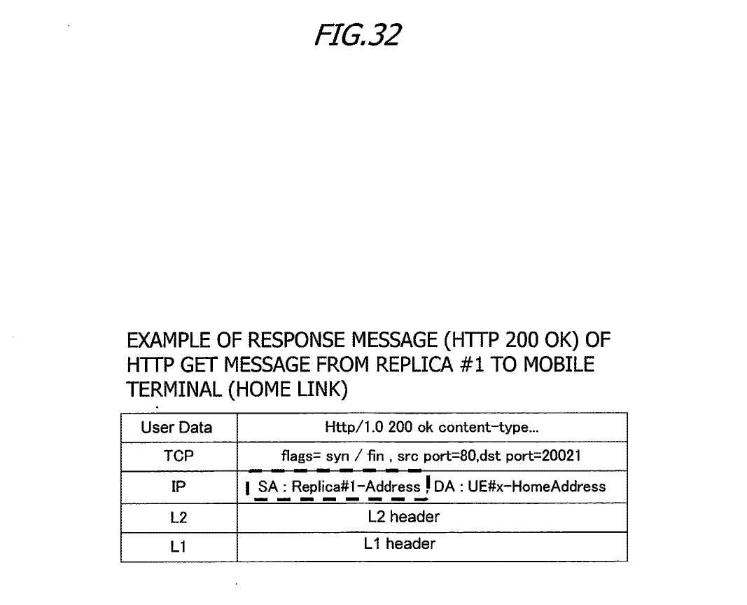

FIG. 32 is a diagram illustrating an example of a packet of the response message (HTTP 200 OK) of the HTTP GET message transmitted from the Replica #1 to the mobile terminal 4 in OP32 of FIG. 30. The transmission source address of the response message of the HTTP GET message of the example illustrated in FIG. 32 is the home address of the virtual proxy 2 in the Replica #1, that is, the address (Replica#1-Address) of the Replica #1. Furthermore, the destination address is the home address (UE#x-HomeAddress) of the mobile terminal 4.

The packet of the BU transmitted from the mobile terminal 4 to the terminal home agent 5 in OP36 of FIG. 30 is the same as, for example, the BU packet transmitted from the mobile terminal 4 to the terminal home agent 5 in OP18 of FIG. 10 (see FIG. 15).

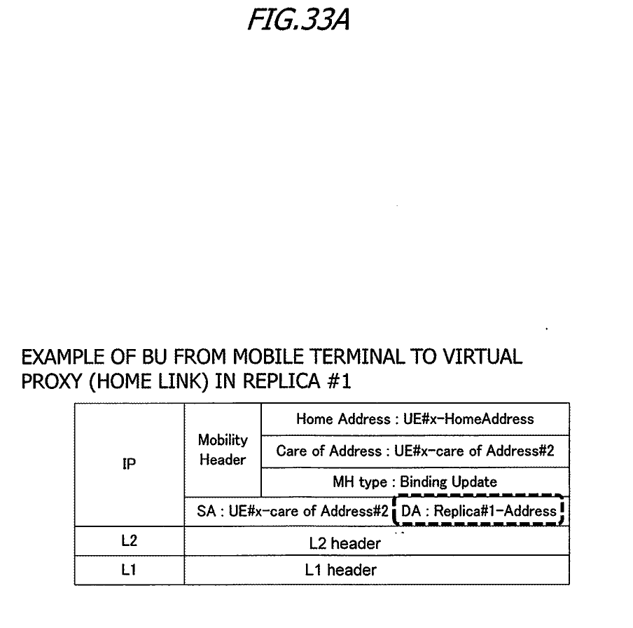

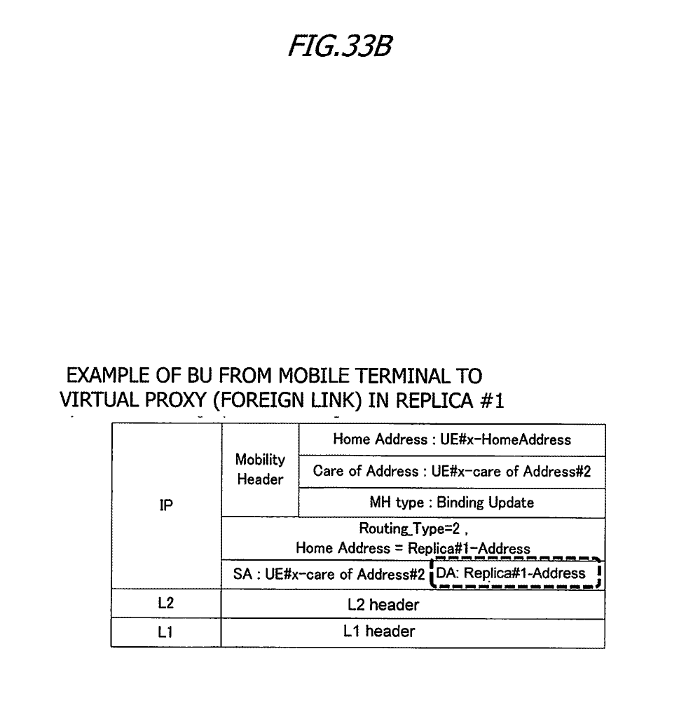

FIG. 33A is a diagram illustrating an example of a packet of the BU transmitted in OP39 of FIG. 30, from the mobile terminal 4 to the virtual proxy 2 in the Replica #1 that is establishing a session. In OP39 of FIG. 30, the mobile terminal 4 has moved to the foreign link and acquired the care-of address in the link at the movement destination. Therefore, the care-of address (UE#x-care of Address#2) of the mobile terminal 4 acquired in the movement destination link is stored in the “care of address” field in the IP mobile header of the BU illustrated in FIG. 33A. Furthermore, the care-of address (UE#x-care of Address#2) of the mobile terminal 4 in the link at the movement destination is stored for the transmission source address of the BU. The destination address of the BU is the home address of the virtual proxy 2 in the Replica #1, that is, the address (Replica#1-Address) of the Replica #1. Note that the example illustrated in FIG. 33A is an example when the virtual proxy 2 in the Replica #1 handles the link connecting the Replica #1 as the home link.

FIG. 33B is a diagram illustrating an example of a packet of the BU transmitted in OP39 of FIG. 30, from the mobile terminal 4 to the virtual proxy 2 in the Replica #1 that is establishing a session. However, the example illustrated in FIG. 33B is an example when the virtual proxy 2 that is establishing a session with the mobile terminal 4 in the Replica #1 handles the link connecting the Replica #1 as a foreign link. Therefore, the destination address of the BU illustrated in FIG. 33B is the care-of address of the virtual proxy 2 in the Replica #1. Since the address of the Replica is also used for the care-of address of the virtual proxy 2 in the second embodiment, the care-of address of the virtual proxy 2 in the Replica #1 is the address (Replica#1-Address) of the Replica #1.

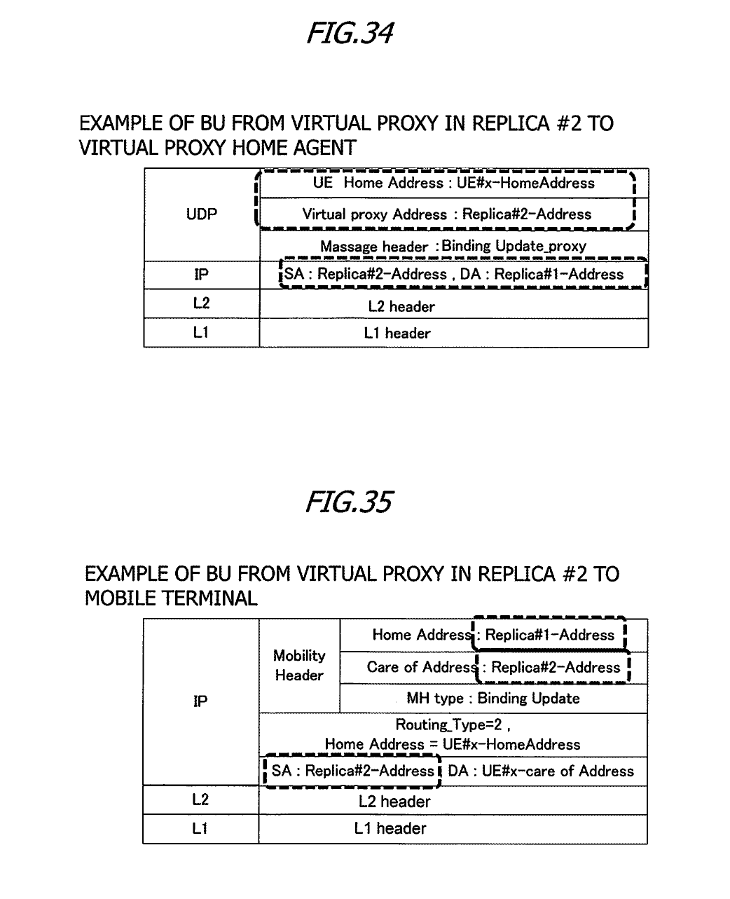

FIG. 34 is a diagram illustrating an example of a packet of the BU transmitted from the virtual proxy 2 in the Replica #2 to the virtual proxy home agent 3 in OP42 of FIG. 30. In OP42 of FIG. 30, the movement of the mobile terminal 4 and the virtual proxy 2 to the link connecting the Replica #2 is completed. The payload section of the BU in this case includes the home address (UE#x-HomeAddress) of the mobile terminal 4 and the care-of address acquired in the link at the movement destination of the virtual proxy 2, that is, the address (Replica#2-Address) of the Replica #2.

Furthermore, the destination address of the BU illustrated in FIG. 34 is the home address of the virtual proxy 2 moved from the Replica #1 to the Replica #2, that is, the address (Replica#1-Address) of the Replica #1. Furthermore, the transmission source address of the BU is the care-of address of the virtual proxy 2 moved from the Replica #1 to the Replica #2, that is, the address (Replica#2-Address) of the Replica #2.

FIG. 35 is a diagram illustrating an example of a packet of the BU transmitted from the virtual proxy 2 in the Replica #2 to the mobile terminal 4 in OP43 of FIG. 30. The care-of address of the virtual proxy 2 in the Replica #2 acquired in the link at the movement destination, that is, the address (Replica#2-Address) of the Replica #2 is stored in the “care of address” field in the IP mobile header of the BU illustrated in FIG. 35. Furthermore, the care-of address of the virtual proxy 2 in the Replica #2 acquired in the link at the movement destination, that is, the address (Replica#2-Address) of the Replica #2 is stored for the transmission source address of the BU. The destination address of the BU is the care-of address (UE#x-care of Address#2) of the mobile terminal 4 acquired in the link at the movement destination.

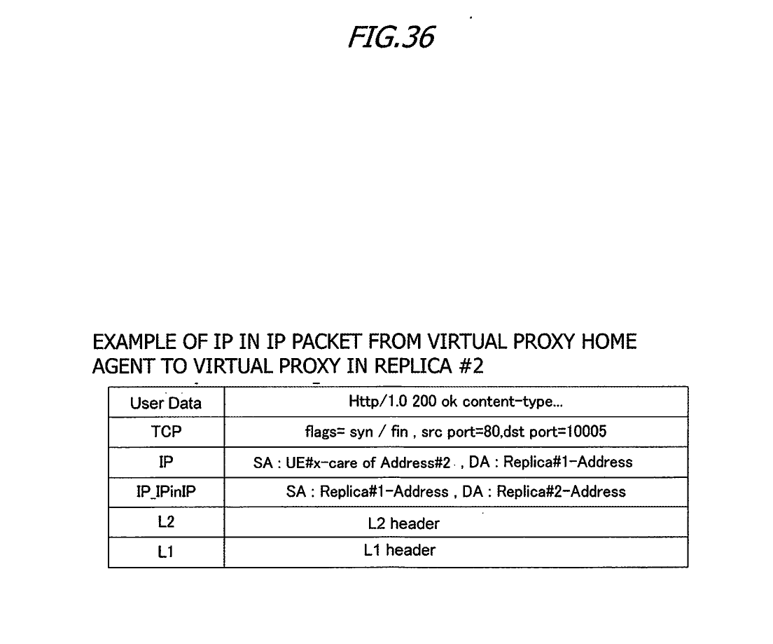

FIG. 36 is a diagram illustrating an example of an IP in IP packet transmitted from the virtual proxy home agent 3 to the virtual proxy 2 in the Replica #2 in OP44 of FIG. 30. The destination address of the IP in IP packet header of the packet illustrated in FIG. 36 is the care-of address of the virtual proxy 2 in the Replica #2, that is, the address (Replica#2-Address) of the Replica #2. The transmission source address of the IP in IP packet header is the address of the virtual proxy home agent 3 that manages the virtual proxy 2 in the Replica #2, that is, the address (Replica#1-Address) of the Replica #1 which is the home address of the virtual proxy 2.

The destination address of the original packet is the home address of the virtual proxy 2 in the Replica #2, that is, the address (Replica#1-Address) of the Replica #1. The transmission source address of the packet section of the original is the care-of address (UE#x-care of Address#2) acquired in the link at the movement destination of the mobile terminal 4.

(Internal Process)

Next, a flow of an internal process of the cache server 1 will be described according to the flow of the example of the sequence illustrated in FIG. 30.

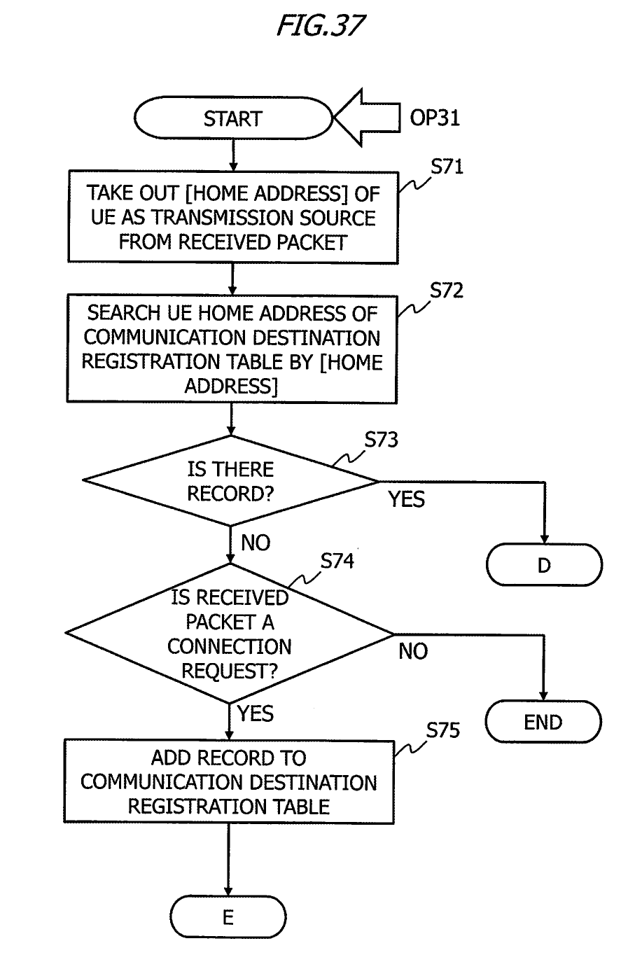

FIG. 37 is an example of the flow chart of the process of the virtual proxy processing unit 13 when a content request to the address of the Replica is received. The flow chart illustrated in FIG. 37 is started in the Replica #1 when, for example, the proxy processing unit 13 receives the content request (see FIG. 31) to the address of the Replica #1 in OP31 of FIG. 30.

In S71, the virtual proxy processing unit 13 takes out the home address of the mobile terminal 4 from the received packet. If the address is stored in the field of “HomeAddress” of the received packet, the virtual proxy processing unit 13 takes out the address as the home address of the mobile terminal 4. If the address is not stored in the field of “HomeAddress” of the received packet, the virtual proxy processing unit 13 takes out the transmission source address as the home address of the mobile terminal 4.

In S72, the virtual proxy processing unit 13 searches the item of “UE Home Address” in the communication destination registration table based on the home address of the mobile terminal 4 taken out from the received packet in S71.

If the communication destination registration table includes a record that matches the home address of the mobile terminal 4 taken out from the received packet in S71 (S73: YES), the process proceeds to S14 of FIG. 20A. If the communication destination registration table does not include a record that matches the home address of the mobile terminal 4 taken out from the received packet in S71 (S73: NO), the process proceeds to S74.

In S74, the virtual proxy processing unit 13 determines whether the received packet is a connection request (TCP SYN packet). If the received packet is a connection request (S74: YES), the process proceeds to S75. If the received packet is not a connection request (S74: NO), there is no corresponding record in the session information table, and the session is not established. Therefore, the process illustrated in FIG. 37 ends.

In S75, the virtual proxy processing unit 13 adds records to the communication destination registration table. The home address of the mobile terminal 4 taken out in S71 and the address of the Replica are stored in the “UE Home Address” and the “Virtual Proxy Home Address”, respectively, of the records added in this case. If the mobile terminal 4 handles the link connecting the Replica as a foreign link, the care-of address of the mobile terminal 4 included in the received packet is stored in the “UE Care-of Address” of the added record. Subsequently, the process proceeds to S18 of FIG. 20B.

Subsequently, as in the process from S18 of FIG. 20B, records are added to the session information table, and a response is transmitted to the mobile terminal 4 as the transmission source of the received packet (connection request).

In OP39 of FIG. 30, the process by the Replica #1 when the Replica #1 receives the BU for notifying the care-of address acquired at the movement destination from the mobile terminal 4 is the same as that of the first embodiment (see FIG. 22). Therefore, the internal process in the Replica #1 in OP39 of FIG. 30 will not be described in detail.

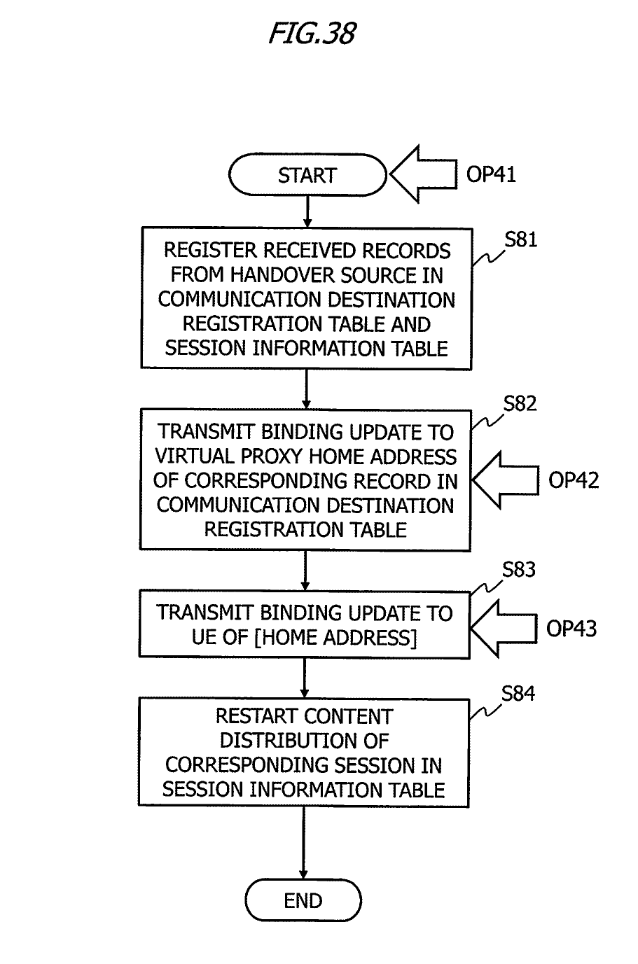

FIG. 38 is an example of a flow chart of a process by the virtual proxy processing unit 13 as a Replica at the handover destination when records of the communication destination registration table and the session information table are received from another Replica. The flow chart illustrated in FIG. 38 is started when records of the communication destination registration table and the session information table are received from another Replica. The flow chart illustrated in FIG. 38 is also started in the Replica #2 when the Replica #2 receives the information of the session from the Replica #1 in OP41 of FIG. 30.

Compared to the corresponding flow chart illustrated in FIG. 23 in the first embodiment, the flow chart illustrated in FIG. 38 does not include the process of capturing the care-of address of the virtual proxy 2 (FIG. 23, S42) and the process of setting the captured care-of address of the virtual proxy 2 for the item of “Virtual Proxy Care-of Address” of the corresponding record in the communication destination registration table (FIG. 23, S43). This is because the second embodiment is based on the premise that the care-of address of the virtual proxy 2 is the address of the Replica.

Processes of S81 to S84 of FIG. 38 are the same as the processes of S41 and S44 to S46 of FIG. 23, respectively. Therefore, the processes of S81 to S84 of FIG. 38 will not be described in detail.

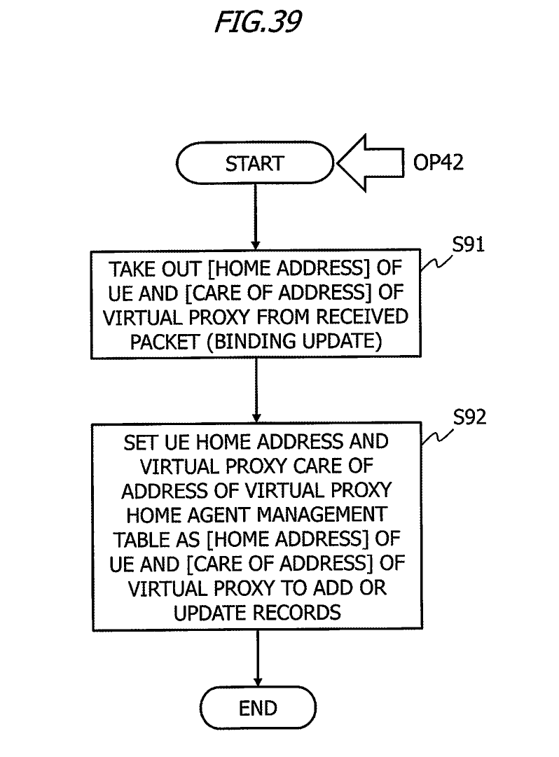

FIG. 39 is an example of a flow chart of a process by the virtual proxy home agent processing unit 16 as the virtual proxy home agent 3 when the BU is received from the virtual proxy 2. The flow chart illustrated in FIG. 39 is started when the BU is received from the virtual proxy 2. The flow chart illustrated in FIG. 39 is also started in the Replica #1 including the virtual proxy home agent 3 when the virtual proxy home agent 3 receives the BU (see FIG. 34) from the virtual proxy 2 moved to the Replica #2 in OP42 of FIG. 30.

In S91, the virtual proxy home agent processing unit 16 takes out, from the received packet (BU), the home address of the mobile terminal 4 and the care-of address of the virtual proxy 2 moved to the Replica #2 (see FIG. 34). Next, the process proceeds to S92.

In S92, if there is a corresponding entry of the virtual proxy home agent management table 17, the virtual proxy home agent processing unit 16 updates the item of “Virtual Proxy Care-of Address” with the care-of address of the virtual proxy 2 taken out from the received packet (BU). If there is no corresponding entry of the virtual proxy home agent management table 17, the virtual proxy home agent processing unit 16 sets the home address of the mobile terminal 4 taken out from the received packet (BU) and the care-of address of the virtual proxy 2 for the items of “UE Home Address” and “Virtual Proxy Care-of Address” of a record, and adds the records. Subsequently, the process illustrated in FIG. 39 ends.

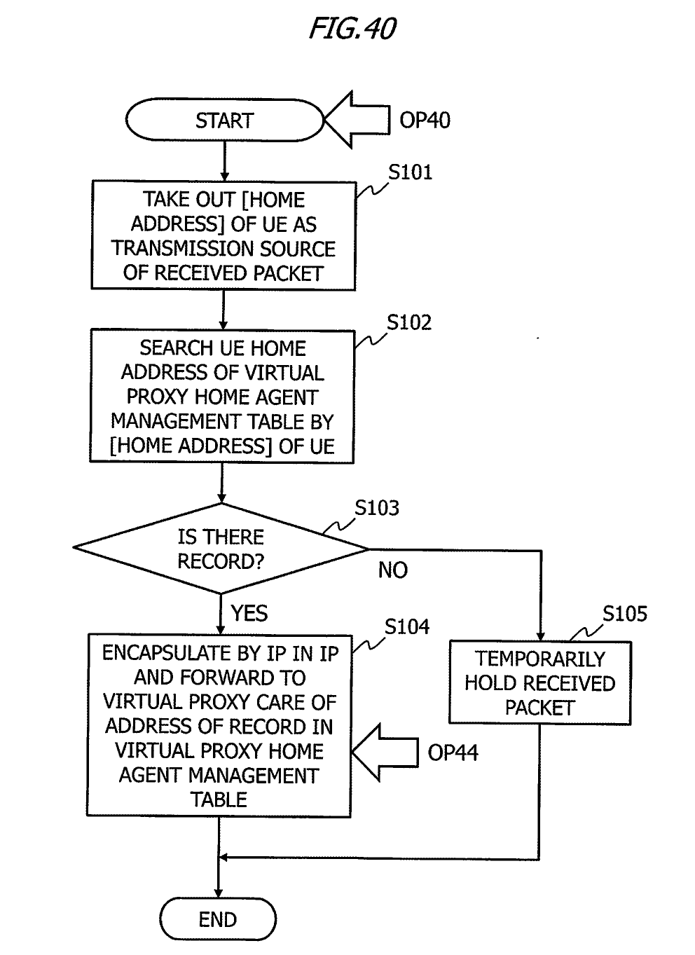

FIG. 40 is an example of a flow chart of a process by the virtual proxy home agent processing unit 16 as the virtual proxy home agent 3 when the TCP packet is received from the mobile terminal 4. The flow chart illustrated in FIG. 40 is started when the TCP packet to the home address of the virtual proxy 2 managed by the virtual proxy home agent 3 is received from the mobile terminal 4. The flow chart illustrated in FIG. 40 is also started in the Replica #1 including the virtual proxy home agent 3 when the virtual proxy home agent 3 receives data from the mobile terminal 4 moved to another link in OP40 of FIG. 30.

In S101, the virtual proxy home agent processing unit 16 takes out the home address of the mobile terminal 4 of the transmission source from the received packet (TCP packet) (see FIGS. 11A and 11B). Next, the process proceeds to S102.

In S102, the virtual proxy home agent processing unit 16 searches the item of “UE Home Address” of the virtual proxy home agent management table 17 based on the home address of the mobile terminal 4 acquired from the received packet. If there is a record of the virtual proxy home agent management table 17 in which the value of the item of “UE Home Address” matches the home address of the mobile terminal 4 acquired from the received packet (S103: YES), the process proceeds to S104.

If there is no record of the virtual proxy home agent management table 17 in which the value of the item of “UE Home Address” matches the home address of the mobile terminal 4 acquired from the received packet (S103: NO), the process proceeds to S105.

In S104, the virtual proxy home agent processing unit 16 forwards the received packet to the address of the item of “Virtual Proxy Care-of Address” of the corresponding record in the virtual proxy home agent management table 17. In this case, the received packet is encapsulated by IP in IP. The process of 5104 is equivalent to, for example, the process of OP44 of FIG. 30. Subsequently, the process illustrated in FIG. 40 ends.

If the Replica as the virtual proxy 2 receives the packet encapsulated by IP in IP, the virtual proxy processing unit 13 of the Replica removes the capsule of the received packet and then executes, for example, the same process as in FIG. 37.

In S105, since the virtual proxy home agent processing unit 16 does not know the care-of address of the virtual proxy 2 as the forwarding destination of the received packet, the received packet is temporarily held in the buffer. Subsequently, the process illustrated in FIG. 40 ends.

### Operation and Effects of Second Embodiment

In the second embodiment, the address of the Replica is set for the home address and the care-of address of the virtual proxy 2, and this can reduce the addresses paid out to the virtual proxy 2.

Furthermore, by setting the address of the Replica for the home address and the care-of address of the virtual proxy 2, for example, the process for capturing the home address of the virtual proxy 2 as in S10 of FIG. 19 of the first embodiment and the process for capturing the care-of address of the virtual proxy as in S42 of FIG. 23 are eliminated. The processing load on the Replica is reduced.

Furthermore, the process of returning the HTTP redirection to the HTTP GET message from the mobile terminal 4 as in OP31 and OP32 of FIG. 30 is not executed in the second embodiment. The communication procedure between devices can be reduced, and this is efficient.

### Third Embodiment

In a third embodiment, one representative home address is used as the home addresses of the virtual proxies 2 in the content distribution system 100. As a result, one address is paid out to the home addresses of the virtual proxies 2 in the content distribution system 100, and the addresses can be reduced. The address of the Replica is used for the care-of address of the virtual proxy 2 as in the second embodiment. In the third embodiment, the description common to the first embodiment and the second embodiment will be omitted.

In the third embodiment, the hardware configuration and the functional blocks of the cache server 1 are common to the first embodiment and are as illustrated in FIGS. 4 and 5.

(Data Structures)

In the third embodiment, the data structures of the communication destination registration table, the session information table, and the virtual proxy home agent management table 17 of the cache server 1 are the same as those of the second embodiment.

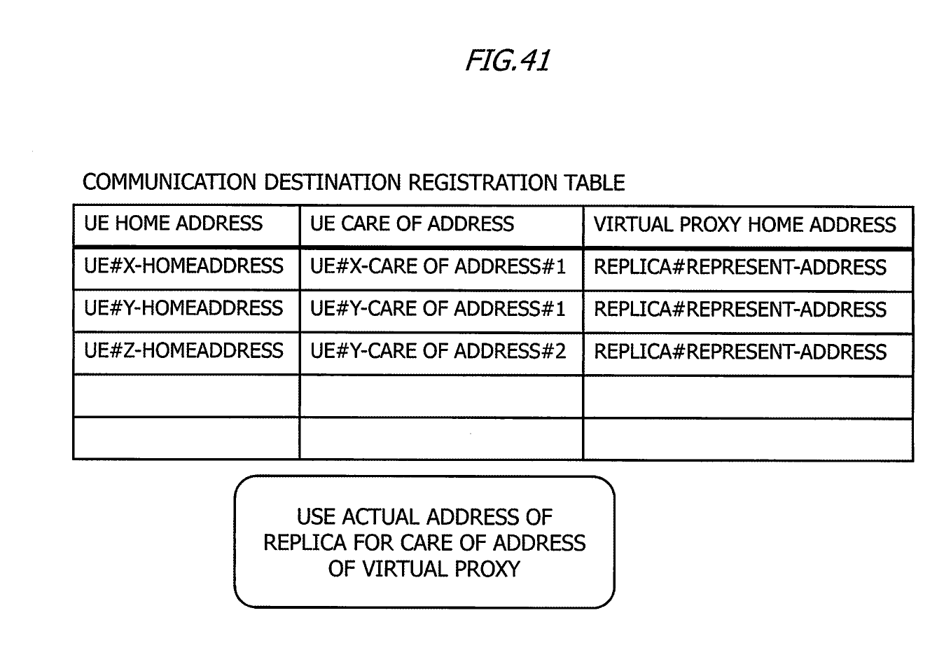

FIG. 41 is an example of the communication destination registration table according to the third embodiment. As in the second embodiment, the records of the communication destination registration table in the third embodiment include the items of “UE Home Address”, “UE Care-of Address”, and “Virtual Proxy Home Address”.

In the third embodiment, since one representative home address is used for the home addresses of the virtual proxies 2 in the content distribution system 100, the representative home address (Replica#represent-Address) is stored in all records of the “Virtual Proxy Home Address” of the records in the communication destination registration table.

For the representative home address of the virtual proxy 2, an address that does not overlap with any addresses of the Replicas in the content distribution system 100 may be used, or one of the addresses of the Replicas may be used.

(Flow of Process)

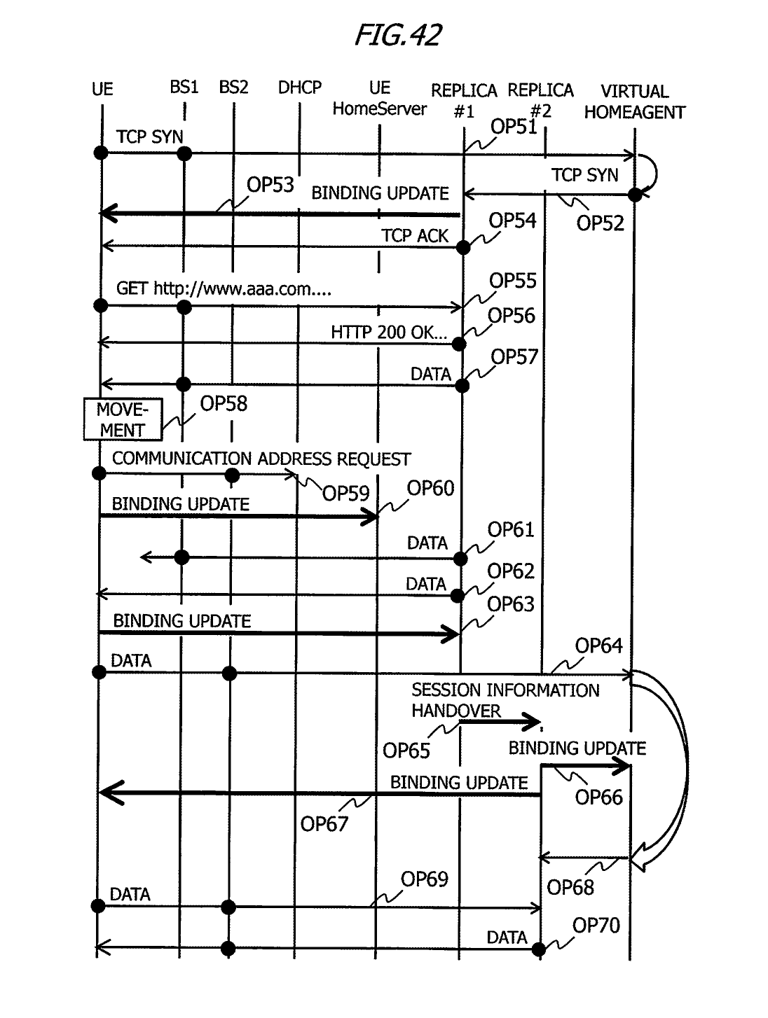

FIG. 42 is a diagram illustrating an example of a sequence of a process in the content distribution system 100 according to the third embodiment. As in FIG. 10 of the first embodiment and FIG. 30 of the second embodiment,

FIG. 42 illustrates a sequence from the establishment of the communication session between the mobile terminal 4 and the Replica #1 to the movement of the mobile terminal 4 and the corresponding completion of the movement of the virtual proxy 2 in the content distribution network illustrated in FIG. 3. In FIG. 42, it is assumed that the mobile terminal 4 handles the Replica #1 as the home link.

In OP51, the mobile terminal 4 transmits a TCP SYN packet to the representative home address. This packet is transferred to the virtual proxy home agent 3 that manages the virtual proxy.

In OP52, the virtual proxy home agent 3 acquires the care-of address of the mobile terminal 4 of the transmission source from the received packet to detect the Replica #1 near the mobile terminal 4 and forwards the received TCP SYN packet to the Replica #1. In FIG. 42, since to the mobile terminal 4 is connected to the home link at the time of OP51, the care-of address is not included. Therefore, the home address is taken out from the received packet instead of the care-of address.

Furthermore, the content distribution system 100 illustrated in FIG. 3 is assumed in FIG. 42, and the virtual proxy home agent 3 exists in the Replica #1. Therefore, the communication of OP52 is actually an internal process of the Replica #1. The packet is encapsulated by IP in IP to forward the packet to a Replica different form the Replica #1 in which the virtual proxy home agent 3 exists.

In OP53, the Replica #1 receives the TCP SYN packet from the virtual proxy home agent 3 to regard that the virtual proxy 2 is moved and transmits the BU to the mobile terminal 4 as a communication partner.

For example, if the representative home address is the address of the Replica #1, the movement destination of the virtual proxy 2 is the home link, and the BU does not include the care-of address of the virtual proxy 2. For example, if the representative home address is an address different from the address of the Replica #1, the movement destination of the virtual proxy 2 is a foreign link, and the BU includes the care-of address of the virtual proxy 2. The care-of address of the virtual proxy 2 in this case is the address of the Replica #1.

In OP54, the virtual proxy 2 in the Replica #1 transmits TCP ACK to the mobile terminal 4. As a result, a communication session between the mobile terminal 4 and the Replica #1 as the virtual proxy 2 is established.

In OP55, the mobile terminal 4 handles the home address or the care-of address of the virtual proxy 2 notified by the BU as the destination address and transmits the HTTP GET message. The HTTP GET message reaches the Replica #1. If the BU includes the care-of address, the care-of address of the virtual proxy 2 is the destination of the HTTP GET message. If the BU does not include the care-of address, the home address of the virtual proxy 2 is the destination of the HTTP GET message.

From OP56, the sequence is the same as the sequence from OP14 of FIG. 10. Therefore, the process from OP56 will not be described.

(Examples of Packets)

In the packets exchanged in the processes of the sequence illustrated in FIG. 42, the home addresses of the packets (see FIGS. 31 to 36) described in the second embodiment are replaced with the representative home address. Therefore, the details will not be described.

(Internal Process)

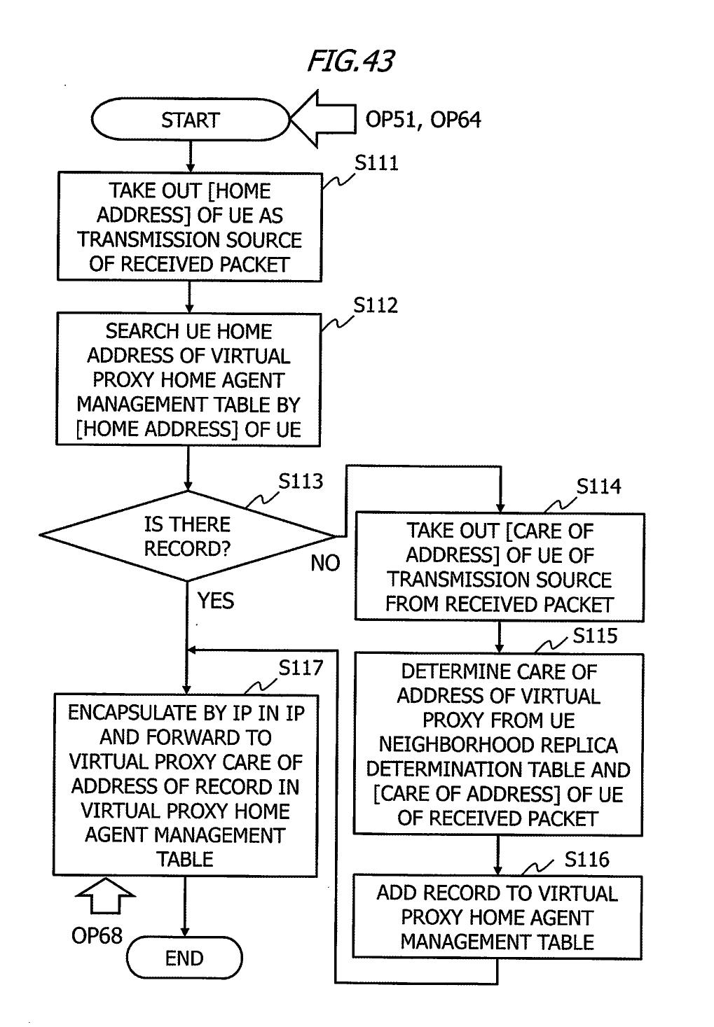

FIG. 43 is an example of a flow chart of a process by the virtual proxy home agent processing unit 16 as the virtual proxy home agent 3 when the TCP packet is received from the mobile terminal 4. The flow chart illustrated in FIG. 43 is started when TCP data to the home address (representative home address) of the virtual proxy 2 managed by the virtual proxy home agent 3 is received from the mobile terminal 4. The flow chart illustrated in FIG. 42 is also started in the Replica #1 including the virtual proxy home agent 3 when the virtual proxy home agent 3 receives data from the mobile terminal 4 in OP51 and OP64 of FIG. 42.

In S111, the virtual proxy home agent processing unit 16 takes out the home address of the mobile terminal 4 as the transmission source from the received packet (TCP packet). The home address of the mobile terminal 4 is stored in the transmission source address or the payload section of the received packet (TCP packet) (see FIGS. 11A and 11B). Next, the process proceeds to S112.

In S112, the virtual proxy home agent processing unit 16 searches the item of “UE Home Address” of the virtual proxy home agent management table 17 based on the home address of the mobile terminal 4 acquired from the received packet. If there is a record of the virtual proxy home agent management table 17 in which the value of the item of “UE Home Address” matches the home address of the mobile terminal 4 acquired from the received packet (S113: YES), the process proceeds to S117.

If there is no record of the virtual proxy home agent management table 17 in which the value of the item of “UE Home Address” matches the home address of the mobile terminal 4 acquired from the received packet (S113: NO), the process proceeds to S114.

In S114, the virtual proxy home agent processing unit 16 takes out the care-of address of the mobile terminal 4 as the transmission source from the received packet (TCP packet). The care-of address of the mobile terminal 4 is stored in the transmission source address of the received packet. Next, the process proceeds to S115.

In S115, the virtual proxy home agent processing unit 16 searches for a Replica near the mobile terminal 4 and determines the care-of address of the virtual proxy 2. Specifically, the virtual proxy home agent processing unit 16 uses the care-of address of the mobile terminal 4 acquired in S114 to search the UE neighborhood Replica determination table and determines the Replica closest to the mobile terminal 4. The Address of the detected Replica serves as the care-of address of the virtual proxy 2. Next, the process proceeds to S37.

In S116, the virtual proxy home agent processing unit 16 sets the home address of the mobile terminal 4 taken out from the received packet (TCP packet) and the care-of address of the virtual proxy 2 determined in S115 for the items of “UE Home Address” and “Virtual Proxy Care-of Address” to add the records to the virtual proxy home agent management table 17. Subsequently, the process proceeds to S117.

In S117, the virtual proxy home agent processing unit 16 forwards the received packet to the address of the item of “Virtual Proxy Care-of Address” of the corresponding record in the virtual proxy home agent management table 17. In this case, the received packet is encapsulated by IP in IP. The process of 5117 is equivalent to, for example, the process of OP68 of FIG. 42. Subsequently, the process illustrated in FIG. 43 ends.

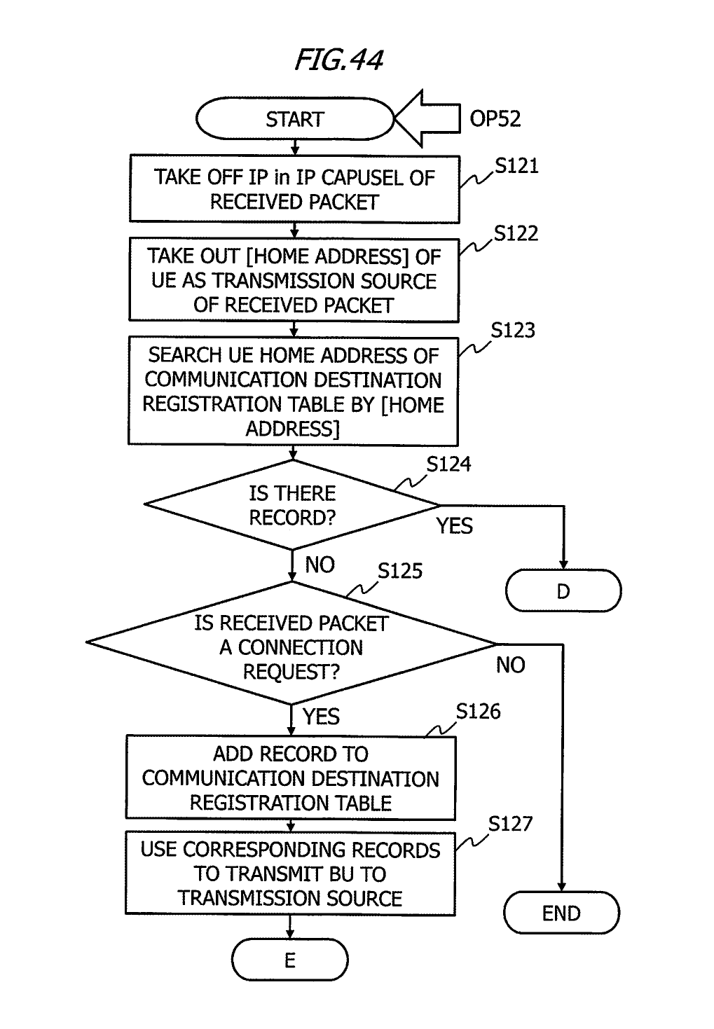

FIG. 44 is an example of a flow chart of a process by the virtual proxy processing unit 13 when the TCP packet is received from the virtual proxy home agent 3. The flow chart illustrated in FIG. 44 is started when, for example, the proxy processing unit 13 receives the TCP packet encapsulated by IP in IP from the virtual proxy home agent 3. For example, when it is assumed that the virtual proxy home agent 3 exists in an device other than the Replica #1 in FIG. 43, the flow chart illustrated in FIG. 44 is also started in the Replica #1 when the Replica #1 receives the TCP packet from the virtual proxy home agent 3 in OP52.

In S121, the virtual proxy processing unit 13 removes the IP in IP capsule of the received packet. Next, the process proceeds to S122.

In S122, the virtual proxy processing unit 13 takes out the home address of the mobile terminal 4 of the transmission source from the received packet. Next, the process proceeds to S123.

In S123, the virtual proxy processing unit 13 searches the item of “UE Home Address” of the communication destination registration table based on the home address of the mobile terminal 4 taken out from the received packet in S122. If the communication destination registration table does not include the record that matches the home address of the mobile terminal 4 taken out from the received packet in S122 (S124: NO), the process proceeds to S125. If the communication destination registration table includes the record that matches the home address of the mobile terminal 4 taken out from the received packet in S122 (S124: YES), the process proceeds to S14 of FIG. 20A. The processes after S14 of FIG. 20A are as described above, and the description will not be repeated.

In S125, the virtual proxy processing unit 13 determines whether the received packet is a connection request. An example of the connection request is a TCP SYN packet. If the received packet is a connection request (S125: YES), the process proceeds to S126. If the received packet is not a connection request (S125: NO), there is no record in the communication destination registration table, and the session with the transmission source of the received packet is not established. Therefore, the process is not executed for the received packet, and for example, the received packet is discarded. Subsequently, the process illustrated in FIG. 44 ends.

In S126, the virtual proxy processing unit 13 adds the records to the communication destination registration table. The “UE Home Address”, the “UE Care-of Address”, and the “Virtual Proxy Home Address” of the added records are the home address of the mobile terminal 4 acquired in S122, the care-of address of the mobile terminal 4 acquired from the received packet, and the home address (representative home address) of the virtual proxy 2, respectively. The addition of the record to the communication destination registration table indicates that the virtual proxy 2 is moved to the Replica. Note that the care-of address of the mobile terminal 4 does not exist if the mobile terminal 4 is connected to the home link. Next, the process proceeds to S127.

In S127, since the virtual proxy 2 is moved, the BU is transmitted to the mobile terminal 4 as the communication partner. The home address of the virtual proxy 2 included in the BU is the representative home address, and the care-of address is the address of the Replica. Subsequently, the process illustrated in FIG. 44 ends.

In the third embodiment, the home address of the virtual proxy 2 is the representative home address, and the care-of address is the address of the Replica. Therefore, the process of capturing the home address of the virtual proxy 2 in S126 and the process of capturing the care-of address of the virtual proxy 2 in S127 are not executed.

The internal processes by the cache server other than the processes illustrated in FIGS. 43 and 44 are common to the second embodiment, and the description will not be repeated.

### Operation and Effect of Third Embodiment

Since the representative home address is used as the home address of the virtual proxy 2 in the third embodiment, there is one home address of the virtual proxies 2 in the content distribution system 100. Therefore, according to the third embodiment, the used addresses can be reduced.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device in a content distribution system including a plurality of information processing devices that distribute content, the information processing device comprising:
a first storage unit that stores content;
a second storage unit that stores session information including a home address and a care-of address of a mobile terminal that is establishing a session, a home address for a session with the mobile terminal, distribution content, and a state of the session; and
a processing unit
that updates, when a location registration request is received from a mobile terminal that is establishing a session, session information related to the mobile terminal based on the location registration request, searches for an information processing device located near the mobile terminal based on an address of the mobile terminal included in the location registration request, and notifies the detected information processing device of the session information after the update related to the mobile terminal and
that transmits, when session information related to a mobile terminal that is establishing a session with another information processing device is received, to the mobile terminal, a location registration request including an address used in a session with the mobile terminal included in the session information and distributes content included in the session information.

2. The information processing device according to claim 1, wherein
the session information further includes a distribution completion position in the distribution content, and
the processing unit starts distributing the content included in the received session information from the distribution completion position included in the session information.

3. The information processing device according to claim 1, wherein
the processing unit uses an address of the information processing device as the home address and a care-of address for the session with the mobile terminal.

4. The information processing device according to claim 1, wherein
the processing unit uses a representative home address as the home address for the session with the mobile terminal and uses the address of the information processing device as the care-of address for the session with the mobile terminal.

5. A content distribution method in a content distribution system including a plurality of information processing devices that distribute content, wherein the information processing device
stores content in a first storage unit,
stores, in a second storage unit, session information including a home address and a care-of address of a mobile terminal that is establishing a session, a home address for a session with the mobile terminal, distribution content, and a state of the session,
updates, when a location registration request is received from a mobile terminal that is establishing a session, session information related to the mobile terminal based on the location registration request, searches for an information processing device located near the mobile terminal based on an address of the mobile terminal included in the location registration request, and notifies the detected information processing device of the session information after the update related to the mobile terminal, and
transmits, when session information related to a mobile terminal that is establishing a session with another information processing device is received, to the mobile terminal, a location registration request including an address used in a session with the mobile terminal included in the session information and distributes content included in the session information.

6. A content distribution system including a plurality of information processing devices that distribute content, each information processing device comprising:
a first storage unit that stores content;
a second storage unit that stores session information including a home address and a care-of address of a mobile terminal that is establishing a session, a home address for a session with the mobile terminal, distribution content, and a state of the session; and
a processing unit
that updates, when a location registration request is received from a mobile terminal that is establishing a session, session information related to the mobile terminal based on the location registration request, searches for an information processing device located near the mobile terminal based on an address of the mobile terminal included in the location registration request, and notifies the detected information processing device of the session information after the update related to the mobile terminal and
that transmits, when session information related to a mobile terminal that is establishing a session with another information processing device is received, to the mobile terminal, a location registration request including an address used in a session with the mobile terminal included in the session information and distributes content included in the session information.
